(19) United States
(12) Patent Application Publication
(10) Pub. No.: US 2026/0214356 A1
(43) Pub. Date: Jul. 23, 2026

(54) IMAGE SENSOR AND METHOD OF OPERATING THE SAME

(71) Applicant: SAMSUNG ELECTRONICS CO., LTD., Suwon-si (KR)

(72) Inventors: Seunghoon Jung, Suwon-si (KR); Seongyeop Park, Suwon-si (KR); Inho Song, Suwon-si (KR)

(73) Assignee: SAMSUNG ELECTRONICS CO., LTD., Suwon-si (KR)

(21) Appl. No.: 19/441,230

(22) Filed: Jan. 6, 2026

(30) Foreign Application Priority Data
Jan. 21, 2025 (KR) 10-2025-0008984

(51) Int. Cl. H04N 25/767; H04N 25/76; H04N 25/771; H04N 25/78

(52) U.S. Cl. CPC H04N 25/767; H04N 25/771; H04N 25/7795; H04N 25/78

(57) ABSTRACT

An image sensor is provided. The image sensor includes: an analog-to-digital converter circuit configured to convert pixel signals received in units of rows of a pixel array into pieces of pixel data; and a data bus configured to transmit the pieces of pixel data to an image signal processor. The data bus includes: channel memories, wherein a first channel memory includes N column memories configured to store N different pieces of pixel data among the pieces of pixel data; and multiplexers respectively corresponding to the channel memories, configured to share N selection signals. A first multiplexer is configured to sequentially select pixel data from the first channel memory based on the N selection signals, and to output the selected pixel data as channel data.

### CROSS-REFERENCE TO RELATED APPLICATION

This application is based on and claims priority to Korean Patent Application No. 10-2025-0008984, filed on January 21, 2025, in the Korean Intellectual Property office, the disclosure of which is incorporated by reference herein in its entirety.

### BACKGROUND

The present disclosure relates to a semiconductor circuit, and more particularly, to an image sensor including a data bus and a method of operating the image sensor.

Image sensors generate images of objects by using photoelectric conversion devices which react according to intensity of light reflected from the objects. An image sensor may generate an image by performing analog-to-digital conversion of an electrical signal generated by a photoelectric conversion device. A plurality of pixel signals output by the pixel array of the image sensor may be converted into pixel data by a plurality of analog-to-digital converters, and a plurality of pieces of pixel data may be transmitted to an image signal processor, which performs image processing on the image. As the resolution of the image sensor increases, the number of a plurality of analog-to-digital converters may increase. Signal congestion may occur as the number of input lines and the number of transmission lines of a data bus, which transmits a plurality of pieces of pixel data respectively generated by a plurality of analog-to-digital converters to the image signal processor, increase.

### SUMMARY

One or more example embodiments provide an image sensor having reduced signal congestion and a method of operating the image sensor.

According to an aspect of an example embodiment, an image sensor includes: a pixel array including a plurality of pixels; an analog-to-digital converter circuit configured to convert a plurality of pixel signals received in units of rows of the pixel array into a plurality of pieces of pixel data; and a data bus configured to transmit the plurality of pieces of pixel data to an image signal processor. The data bus includes: a plurality of channel memories, wherein a first channel memory among the plurality of channel memories includes N column memories (N is an integer of 2 or more) configured to store N different pieces of pixel data among the plurality of pieces of pixel data; and a plurality of multiplexers respectively corresponding to the plurality of channel memories, configured to share N selection signals, wherein a first multiplexer among the plurality of multiplexers is configured to sequentially select pixel data from the first channel memory based on the N selection signals, and to output the selected pixel data as channel data.

According to another aspect of an example embodiment, an image sensor includes: a pixel array including a plurality of pixels; an analog-to-digital converter circuit configured to convert a plurality of pixel signals received in units of rows of the pixel array into a plurality of pieces of pixel data, respectively; a shift register configured to generate N selection signals, based on an enable signal and a clock signal; a plurality of channel memories, wherein a first channel memory among the plurality of channel memories includes N column memories (N is an integer of 2 or more), and is configured to store N pieces of pixel data among the plurality of pieces of pixel data; and a plurality of multiplexers configured to share the N selection signals, wherein a first multiplexer among the plurality of multiplexers is configured to sequentially select and output the N pieces of pixel data stored in the first channel memory based on the N selection signals.

According to another aspect of an example embodiment, a method of operating an image sensor, includes: outputting, by a pixel array, a plurality of pixel signals; converting, by an analog-to-digital converter circuit, the plurality of pixel signals to a plurality of pieces of pixel data; receiving, by each of a plurality of channel memories, N different pieces of pixel data (N is an integer of 2 or more) among the plurality of pieces of pixel data; and sequentially outputting, by each of a plurality of multiplexers, N pieces of pixel data stored in a corresponding channel memory among the plurality of channel memories based on N selection signals, the N selection signals being shared by the plurality of multiplexers.

According to another aspect of an example embodiment, an image sensor including a pixel array including a plurality of pixels configured to generate a pixel signal based on an optical signal received by each of the plurality of pixels, an analog-to-digital converter circuit configured to convert a plurality of pixel signals received in units of rows of the pixel array into a plurality of pieces of pixel data, and a data bus configured to transmit the plurality of pieces of pixel data to an image signal processor, wherein the data bus includes a shift register configured to generate a plurality of selection signals based on an enable signal and a clock signal, and a multiplexer configured to sequentially select and output the plurality of pieces of pixel data based on the plurality of selection signals.

The shift register may include a plurality of flip-flops connected in series, and operate according to a clock signal, wherein the plurality of flip-flops are configured to sequentially output an enable signal as a plurality of selection signals in response to a plurality of first edges of the clock signal.

The data bus may further include a plurality of column memories configured to receive a plurality of pieces of pixel data from an analog-digital converter circuit and store the plurality of pieces of pixel data, wherein the plurality of column memories are arranged in a first direction in parallel.

The data bus may include a plurality of first bit lines extending in a first direction and configured to be connected to a corresponding bit memory among a plurality of bit memories of a plurality of column memories, a plurality of second bit lines extending in a second direction perpendicular to the first direction and configured to be connected to a corresponding first bit line among the plurality of first bit lines to output voltages of the plurality of first bit lines, and a plurality of switching circuits configured to connect a corresponding column memory among the plurality of column memories to the plurality of first bit lines according to a corresponding selection signal among a plurality of selection signals.

The image sensor may further include a data alignment circuit configured to align a plurality of pieces of pixel data received during a plurality of periods from a plurality of multiplexers, and output the aligned plurality of pieces of pixel data in units of two or more adjacent pieces of pixel data to an image signal processor.

### BRIEF DESCRIPTION OF DRAWINGS

The above and other aspects and features of the present disclosure will be more clearly understood from the following description of example embodiments, taken in conjunction with the accompanying drawings, in which:

FIG. 1 is a block diagram of an image sensor according to an example embodiment;

FIG. 2 is a schematic data bus according to an example embodiment;

FIG. 3 is a circuit diagram of a plurality of multiplexers provided in a data bus according to an example embodiment;

FIG. 4A is a shift register provided in a data bus according to an example embodiment, and FIG. 4B is a timing diagram of the shift register according to an example embodiment;

FIGS. 5A and 5B illustrate outputs of a data bus according to example embodiments;

FIG. 6A is a data alignment circuit provided in a data bus according to an example embodiment, and FIG. 6B illustrates alignment of a plurality of pieces of pixel data in the data alignment circuit according to an example embodiment;

FIG. 7 is a data bus according to an example embodiment;

FIG. 8 is a timing diagram illustrating data output of a data bus according to an example embodiment;

FIG. 9 is a flowchart of a method of operating an image sensor, according to an example embodiment;

FIGS. 10A and 10B are image sensors according to comparative examples, and FIG. 10C is an image sensor according to an example embodiment;

FIG. 11 is an image sensor according to an example embodiment;

FIG. 12 is a data bus according to an example embodiment;

FIG. 13 is a circuit diagram of a multiplexer and a shift register provided in a data bus according to an example embodiment;

FIG. 14 is a timing diagram of a shift register and a multiplexer provided in a data bus according to an example embodiment;

FIG. 15 is a flowchart of a method of operating an image sensor, according to an example embodiment;

FIG. 16 is a stack structure of an image sensor according to an example embodiment; and

FIG. 17 is a block diagram of an electronic device including an image sensor according to an example embodiment.

### DETAILED DESCRIPTION

Example embodiments will be described in detail with reference to the accompanying drawings. Like components are denoted by like reference numerals throughout the specification, and repeated descriptions thereof are omitted. Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

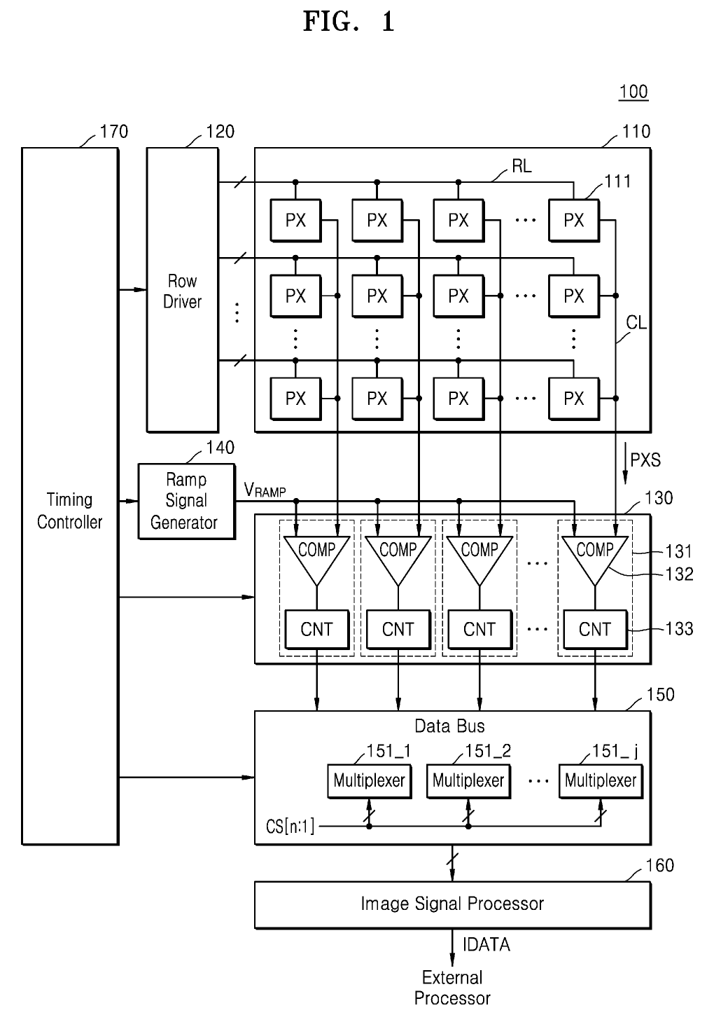

FIG. 1 is a block diagram of an image sensor 100 according to an example embodiment.

The image sensor 100 may generate image data IDATA by converting a received optical signal (image information) into an electrical digital signal. The image sensor 100 may be mounted on an electronic device having an image or light sensing function. For example, the image sensor 100 may be mounted on an electronic device, such as a camera, a smartphone, a wearable device, an Internet of Things (IoT) device, home appliance devices, a personal computer (PC), a personal digital assistant (PDA), a portable multimedia player (PMP), a navigation device, a drone, and an advanced driver assistance system (ADAS). In addition, the image sensor 100 may be mounted on an electronic device provided as a component of vehicles, furniture, manufacturing equipment, doors, various measuring devices, etc.

Referring to FIG. 1, the image sensor 100 may include a pixel array 110, a row driver 120, an analog-to-digital converter circuit 130 (hereinafter, referred to as an ADC circuit), a ramp signal generator 140, a data bus 150, an image signal processor 160, and a timing controller 170. The row driver 120, the ADC circuit 130, and the ramp signal generator 140 may be referred to as readout circuits.

The pixel array 110 may include a plurality of row lines RL, a plurality of column lines CL, and a plurality of pixels PX arranged in a matrix and connected to the plurality of row lines RL and the plurality of column lines CL. The plurality of pixels PX may include active pixel sensors (APSs).

In example embodiments, pixels PX arranged on the same column may be connected to the same column line CL. However, example embodiments are not limited thereto, and depending on the arrangement of pixels PX, the pixels PX arranged on the same column may also be connected to a different column line CL. The pixel PX may output a pixel signal PXS (for example, a pixel voltage) via a corresponding column line CL.

The pixel PX may sense light by using a photoelectric conversion device, and output an electrical signal according to the sensed light. The photoelectric conversion device may include a photo sensing device including an organic material or an inorganic material, such as a photodiode (inorganic photodiode), an organic photo film, a perovskite photodiode, a photo transistor, a photo gate, and a pinned photodiode. Hereinafter, a photodiode is described as an example of the photoelectric conversion device.

Microlenses for converging light may be arranged on an upper portion of each of the plurality of pixels PX or on an upper portion of each of pixel groups including adjacent pixels PX. In an example embodiment, the microlens may be replaced with another light converging device, for example, a nano-prism or a meta-lens.

A color filter for transmitting light in a particular spectrum range may be arranged on each of the plurality of pixels PX, and each of the pixels PX may sense light in the particular spectrum range from light received through the microlens based on the corresponding color filter. For example, the pixel array 110 may include a red pixel which converts light in a red spectrum range into an electrical signal, a green pixel which converts light in a green spectrum range into an electrical signal, and a blue pixel which converts light in a blue spectrum range into an electrical signal. However, example embodiments are not limited thereto, and the pixel array 110 may further include a white pixel, or the pixel array 110 may include pixels according to other color combinations, such as a cyan pixel, a yellow pixel, a green pixel, and a magenta pixel.

The row driver 120 may drive the pixel array 110 in units of rows. The row driver 120 may decode a row control signal (for example, a row address signal) received from the timing controller 170, and select at least one row among a plurality of rows of the pixel array 110 in response to the decoded row control signal. The row driver 120 may sequentially select the plurality of rows of the pixel array 110 during a plurality of readout periods included in one frame period.

The row driver 120 may provide control signals, for example, a reset control signal, a selection signal, a transmission control signal, a conversion control signal, or the like, to the pixels PX arranged on the selected row via the row lines RL. The pixels PX arranged on the selected row may output the pixel signals PXS, such as pixel voltages, in response to received control signals. Each of the pixels PX arranged on the selected row may output a reset signal and an image signal to the ADC circuit 130 as the pixel signals PXS via a corresponding column line CL among the plurality of column lines CL. Accordingly, one row of the pixel array 110 may be read out in a readout period, and the plurality of rows of the pixel array 110 may be read out during the plurality of readout periods.

The ADC circuit 130 may convert a plurality of pixel signals PXS (for example, a plurality of pixel voltages) provided by the pixel array 110 into a plurality of pixel values, based on a ramp signal V_{RAMP} provided by the ramp signal generator 140.

The ADC circuit 130 may include a plurality of ADCs 131 corresponding to each of the column lines CL, and each of the plurality of ADCs 131 may include a comparator (COMP) 132 and a counter (CNT) 133.

The plurality of ADCs 131 may convert the pixel signal PXS, which is an analog signal, into pixel data, which is a digital signal, in a correlated double sampling (CDS) method. The plurality of ADCs 131 may sequentially receive a reset signal and an image signal as a pixel signal PXS, generate a reset value and a signal value by analog-to-digital converting the reset signal and the image signal, respectively, and generate a pixel value, that is, pixel data, by subtracting the reset value from the signal value.

The comparator 132 may be referred to as a CDS circuit. The comparator 132 may receive the pixel signal PXS received via the corresponding column line CL among the plurality of column lines CL, and receive the ramp signal V_{RAMP} from the ramp signal generator 140. The comparator 132 may compare the pixel signal PXS to the ramp signal V_{RAMP}, and output a comparison result signal. When the ramp signal V_{RAMP}, of which a level is reduced at a specific slope (or linearly), reaches a level equal to or lower than the pixel signal PXS, the comparator 132 may output the comparison result signal transitioning from a first level (for example, logic high) to a second level (for example, logic low). A time point, at which the ramp signal V_{RAMP} reaches the level equal to the pixel signal PXS and the comparison result signal transitions from the first level to the second level, may be referred to as a decision time point.

By using the CDS method, the comparator 132 may sample and hold the reset signal provided by the pixel PX, and may sample an image signal based on the reset signal. The comparator 132 may receive the reset signal as the pixel signal PXS via the column line CL, compare the reset signal to the ramp signal V_{RAMP}, and output a first comparison result signal. The comparator 132 may also receive the image signal as the pixel signal PXS via the column line CL, compare the image signal to the ramp signal V_{RAMP}, and output a second comparison result signal.

The counter 133 may generate a reset value based on the first comparison result signal output by the comparator 132, and may generate a signal value based on the second comparison result signal. The counter 133 may generate the pixel value (or pixel data) by subtracting the reset value from the signal value.

In an example embodiment, the counter 133 may count the decision time point of the comparison result signal based on a counting clock signal or a counting code (for example, gray code) provided by the timing controller 170. The counter 133 may generate a reset value by counting the decision time point of the first comparison result signal, and may generate a signal value by counting the decision time point of the second comparison result signal.

The ramp signal generator 140 (i.e., a ramp signal generation circuit) may generate the ramp signal V_{RAMP} (i.e., a ramp voltage) in which a level of the ramp signal V_{RAMP} increases (rises up) or decreases (fall down) at a uniform slope. The ramp signal V_{RAMP} may be provided to the ADC circuit 130 as a reference voltage compared to the pixel signal PXS.

The data bus 150 may temporarily store the plurality of pieces of pixel data received from the plurality of ADCs 131, and then provide the plurality of pieces of pixel data to the image signal processor 160.

The data bus 150 according to example embodiments may include a plurality of multiplexers (i.e., decoders or decoder circuits), for example, first through jth (j is an integer of 2 or more) multiplexers 151_1 through 151_j. The first through jth multiplexers 151_1 through 151_j may share a plurality of selection signals, for example, first through nth selection signals CS[n:1]. Each of the first through jth multiplexers 151_1 through 151_j may receive n different pieces of pixel data from n different ADCs 131 (n is an integer of 2 or more) among the plurality of ADCs 131, sequentially select n pieces of pixel data one by one based on the first through nth selection signals CS[n:1], and output the selected n pieces of pixel data. The first through jth multiplexers 151_1 through 151_j may sequentially output n pieces of pixel data during n cycles (or, referred to as n periods).

In an example embodiment, the data bus 150 may receive column control signals, such as an enable signal and a clock signal, from the timing controller 170, and generate first through nth selection signals CS[n:1] based on the column control signals. For example, the data bus 150 may include a shift register, and the shift register may generate first through nth selection signals CS[n:1] based on the enable signal and the clock signal. In an example embodiment, the data bus 150 may receive first through nth selection signals CS[n:1] from the timing controller 170.

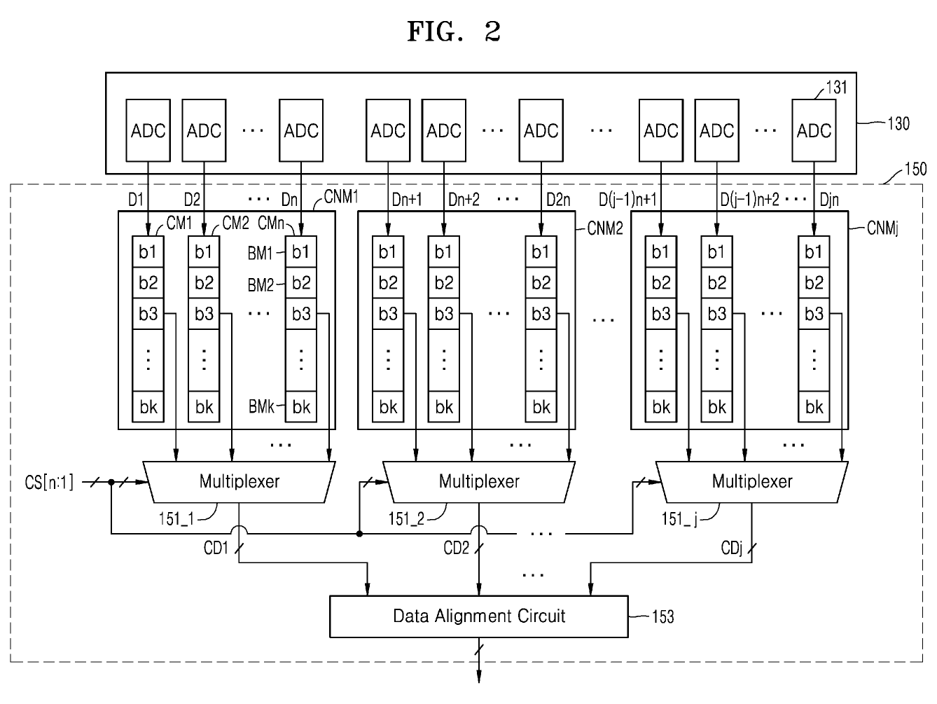

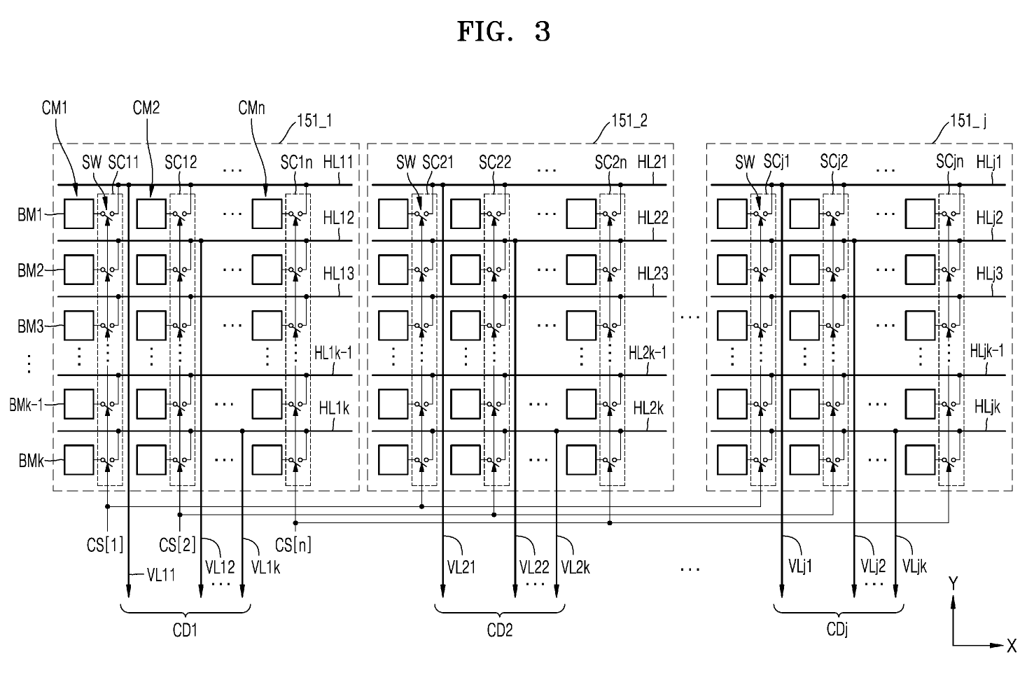

The components of the data bus 150 and the operation of the data bus 150 according to example embodiments are described in detail with reference to FIGS. 2 through 9.

In the data bus 150 according to example embodiments, each of the first through jth multiplexers 151_1 through 151_j may output n pieces of pixel data in series based on a plurality of selection signals (for example, first through nth selection signals CS[n:1]). The number of transmission lines (i.e., output lines) transmitting n pieces of pixel data of the data bus 150 may be less than the number of transmission lines required when the plurality of pieces of pixel data are output in parallel.

In addition, because the first through jth multiplexers 151_1 through 151_j share the first through nth selection signals CS[n:1] received from the timing controller 170, or receive a small number of column control signals (for example, the clock signal and the enable signal) from the timing controller 170 to generate the first through nth selection signals CS[n:1], the number of input lines to which signals are transmitted by the timing controller 170 may be less than the number of input lines required when receiving the plurality of selection signals respectively corresponding to the plurality of pieces of pixel data from the timing controller 170.

Thus, because the number of input lines and transmission lines of the data bus 150 may be reduced, the signal congestion may be reduced. In addition, when the image sensor 100 is implemented as a semiconductor chip, the area of an area where the input lines and the transmission lines are arranged (for example, routing areas) may be reduced.

The image signal processor 160 may perform an image processing operation on the image data IDATA received via the data bus 150. For example, the image signal processor 160 may change a data pattern of the image data IDATA (for example, change a Bayer pattern to an RGB pattern), or perform an image processing operation, such as noise reduction processing, gain adjustment, binning, downsizing, remosaic, and image quality compensation operation, on the image data IDATA, and the image quality compensation may include signal processing, such as black level compensation (i.e., a dark level compensation), lens shading compensation, crosstalk compensation, and bad pixel compensation. In an example embodiment, the image signal processor 160 may receive first image data and second image data having different luminance, and by combining the first image data and the second image data, may generate a high dynamic range (HDR) image.

The image data IDATA processed by the image signal processor 160 may be transmitted to an external processor. For example, the external processor may include a host processor of an electronic device on which the image sensor 100 is mounted. For example, the external processor may include an application processor of a mobile terminal. The image sensor 100 may transmit the image data IDATA to the external processor according to a data communication method based on a set interface, for example, a mobile industry processor interface (MIPI). The external processor may perform an image processing operation on the received image data IDATA. In an example embodiment, the external processor may perform an image processing operation, such as 3A adjustment (auto-focus correction, auto-white balance, and auto-exposure), sharpening, gamma control, resolution scaling (video/preview), and demosaic, on the received image data IDATA.

In an example embodiment, the external processor may perform some of the image processes described as the image processes that may be performed by the image signal processor 160, and the image signal processor 160 may perform some of the image processes described as the image processes performed by the external processor. For example, the external processor may receive the first image data and the second image data having different luminance as the image data IDATA, and generate the HDR image by combining the first image data and the second image data.

The timing controller 170 may control the operation and the operation timing of the row driver 120, the ADC circuit 130, the ramp signal generator 140, and the data bus 150, by outputting a timing control signal to each of the row driver 120, the ADC circuit 130, the ramp signal generator 140, and the data bus 150. In an example embodiment, the timing controller 170 may generate column control signals, such as the enable signal and the clock signal, and may provide column control signals to the data bus 150. In an example embodiment, the timing controller 170 may generate the plurality of selection signals, for example, first through nth selection signals CS[n:1], and provide the first through nth selection signals CS[n:1] to the data bus 150.

FIG. 2 schematically illustrates the data bus 150 according to an example embodiment.

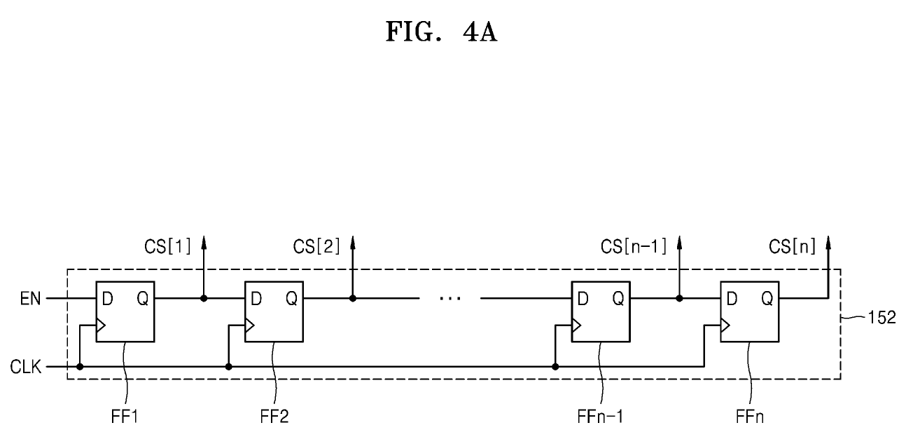

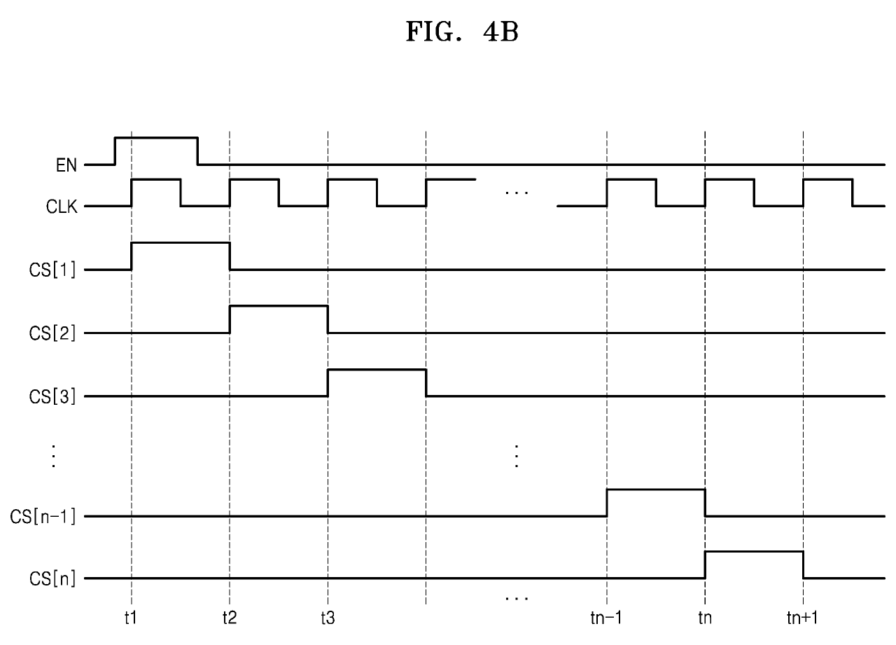

Referring to FIG. 2, the data bus 150 may include a plurality of channel memories, such as first through jth channel memories CNM1 through CNMj (where j is an integer of 2 or more), the plurality of multiplexers such as the first through jth multiplexers 151_1 through 151_j, and a data alignment circuit 153. In an example embodiment, the data bus 150 may further include a shift register (refer to 152 in FIG. 4A) that generates a plurality of selection signals, for example, the first through nth selection signals CS[n:1]. In an example embodiment, the data bus 150 may include a plurality of buffer memories for temporarily storing pixel data output by the plurality of multiplexers. For example, the plurality of buffer memories may be provided between the plurality of multiplexers and the data alignment circuit 153.

Each of the first through jth channel memories CNM1 to CNMj may include a plurality of column memories, for example, first through nth column memories CM1 through CMn. Each of the first through nth column memories CM1 through CMn may store the received pixel data. Each of the first to nth column memories CM1 through CMn may include a plurality of bit memories, for example, first through kth bit memories BM1 through BMk. For example, each of the first through kth bit memories BM1 through BMk may be implemented as a memory device, such as a latch and a volatile memory (for example, static random access memory (SRAM)). The first through kth bit memories BM1 through BMk may respectively store a plurality of bits (for example, first to kth bits b1 through bk) of pixel data.

The first through jth channel memories CNM1 through CNMj may receive the plurality of pieces of pixel data from the plurality of ADCs 131 of the ADC circuit 130. The first through jth channel memories CNM1 through CNMj may receive n different pieces of pixel data from n different ADCs 131 among the plurality of ADCs 131. Each of the first through jth channel memories CNM1 through CNMj may store the received n pieces of pixel data in the first through nth column memories CM1 through CMn. For example, the first channel memory CNM1 may store first through nth pixel data D1 through Dn, the second channel memory CNM2 may store (n+1)th through (2n)th pixel data Dn+1 through D2n, and the jth channel memory CNMj may store ((j-1)n+1)th through (jn)th pixel data D(j-1)n+1 through Djn.

The first through jth multiplexers 151_1 through 151_j may respectively correspond to the first through jth channel memories CNM1 through CNMj. FIG. 2 illustrates that the first through jth multiplexers 151_1 through 151_j are separated from the first through jth channel memories CNM1 through CNMj, but this is for convenience of description, and as illustrated in FIG. 3, the first through jth multiplexers 151_1 through 151_j may be implemented in combination with the first through jth channel memories CNM1 through CNMj.

The first through jth multiplexers 151_1 through 151_j may sequentially select n pieces of pixel data stored in the first through jth channel memories CNM1 through CNMj, based on the first through nth selection signals CS[n:1], for example, first through nth selection signals CS[1] through CS[n] (refer to FIG. 3). The first through jth multiplexers 151_1 through 151_j may simultaneously output first through jth channel data CD1 through CDj, and each of the first through jth multiplexers 151_1 through 151_j may simultaneously output first through kth bits b1 through bk of pixel data. Each of the first through jth multiplexers 151_1 through 151_j may output n pieces of pixel data as channel data in series during n cycles, and accordingly, output the plurality of pieces of pixel data during n cycles.

The data alignment circuit 153 may receive first through jth channel data CD1 through CDj from the first through jth multiplexers 151_1 through 151_j, and may receive the plurality of pieces of pixel data by receiving the first through jth channel data CD1 through CDj n times during n cycles. The data alignment circuit 153 may align the plurality of pieces of pixel data that is received. For example, the data alignment circuit 153 may align the plurality of pieces of pixel data according to an arrangement order of the plurality of ADCs 131. The data alignment circuit 153 may transmit the plurality of pieces of pixel data to the image signal processor (refer to 160 in FIG. 1). In an example embodiment, the data alignment circuit 153 may output the plurality of pieces of pixel data in units of two or more adjacent pieces of pixel data in series to the image signal processor 160. For example, the data alignment circuit 153 may output the plurality of pieces of pixel data in units of two or more adjacent pieces of pixel data in series to the image signal processor 160.

FIG. 3 is a circuit diagram of a plurality of multiplexers provided in a data bus according to an example embodiment.

Referring to FIGS. 2 and 3, each of the plurality of multiplexers, for example, the first through jth multiplexers 151_1 through 151_j, may include a plurality of horizontal bit lines, a plurality of vertical bit lines, and a plurality of switching circuits.

The first multiplexer 151_1 may include first through kth horizontal bit lines HL11 through HL1k, first through kth vertical bit lines VL11 through VL1k, and first through nth switching circuits SC11 through SC1n. The number of horizontal bit lines and vertical bit lines may be equal to the number of bits of pixel data, and the number of switching circuits may be equal to the number of column memories included in a channel memory.

The first through kth horizontal bit lines HL11 through HL1k may extend in a first direction (for example, an X-axis direction), and may be arranged side-by-side (in parallel with each other) in a second direction (for example, a Y-axis direction). In this case, the first direction may be a row direction of the pixel array (110 in FIG. 1), and the second direction may be a column direction of the pixel array 110. The first through kth horizontal bit lines HL11 through HL1k may be arranged between a plurality of first bit memories BM1 through a plurality of kth bit memories BMk of the first through nth column memories CM1 through CMn.

The first through kth vertical bit lines VL11 through VL1k may extend in the second direction, and may be arranged side-by-side in the first direction. The first through kth vertical bit lines VL11 through VL1k may be electrically connected to the first through kth horizontal bit lines HL11 through HL1k, respectively. The first through kth vertical bit lines VL11 through VL1k may be arranged between each of the first through nth column memories CM1 through CMn.

The first through nth switching circuits SC11 through SC1n may respectively correspond to the first through nth column memories. Each of the first through nth switching circuits SC11 through SC1n may include a plurality of switches SW (for example, k switches) respectively connected between the first through kth bit memories BM1 through BMk and the first through kth horizontal bit lines HL11 through HL1k of a column memory.

Each of the first through nth switching circuits SC11 through SC1n may be turned on and turned off according to a corresponding selection signal of the first through nth selection signals CS[1] through CS[n]. For example, the plurality of switches SW provided in the first switching circuit SC11 may be simultaneously turned on and turned off according to the first selection signal CS[1]. The plurality of switches SW of the second switching circuit SC12 may be simultaneously turned on and turned off according to the second selection signal CS[2].

The first through nth switching circuits SC11 through SC1n may be turned on according to an on-level of a corresponding selection signal among the first through nth selection signals CS[1] through CS[n], and provide the first through kth bits b1 through bk of the corresponding column memory to the first through kth horizontal bit lines HL11 through HL1k. The first through kth horizontal bit lines HL11 through HL1k may provide the first through kth bits b1 through bk to the first through kth vertical bit lines VL11 through VL1k. The first through kth bits b1 through bk of the selected column memory may be output via the first through kth vertical bit lines VL11 through VL1k.

For example, when the first channel memory CNM1 includes 16 column memories and the pixel data includes 13 bits, the first multiplexer 151_1 may include 13 horizontal bit lines (for example, first through thirteenth horizontal bit lines), 13 vertical bit lines (for example, first through thirteenth vertical bit lines), and 16 switching circuits (for example, first through sixteenth switching circuits), and each of the first through sixteenth switching circuits may include 13 switches (for example, first through thirteenth switches).

The first through sixteenth switching circuits may be sequentially turned on according to the first through sixteenth selection signals, respectively, and may sequentially provide 16 pieces of pixel data stored in each of the first through sixteenth column memories to the first through thirteenth horizontal bit lines. For example, according to the on-level of the first selection signal CS[1], the first through thirteenth switches of the first switching circuit may be turned on, the first through thirteenth bits of the first pixel data stored in the first column memory CM1 may be provided to first through thirteenth horizontal bit lines, respectively, and the first through thirteenth bits of the first pixel data may be output via the first through thirteenth vertical bit lines respectively connected to the first through thirteenth horizontal bit lines. Thereafter, according to the on-level of the second selection signal CS[2], the first through thirteenth switches of the second switching circuit may be turned on, the first through thirteenth bits of the second pixel data stored in the second column memory CM2 may be provided to the first through thirteenth horizontal bit lines, respectively, and the first through thirteenth bits of the second pixel data may be output via the first through thirteenth vertical bit lines respectively connected to the first through thirteenth horizontal bit lines. In this manner, 16 pieces of pixel data stored in the first through sixteenth column memories may be sequentially and respectively selected and output by the first through sixteenth selection signals.

The second multiplexer 151_2 may include first through kth horizontal bit lines HL21 through HL2k, first through kth vertical bit lines VL21 through VL2k, and first through nth switching circuits SC21 through SC2n, and the jth multiplexer 151_j may include first through kth horizontal bit lines HLj1 through HLjk, first through kth vertical bit lines VLj1 through VLjk, and first through kth switching circuits SCj1 through SCjn. In this case, the first through kth horizontal bit lines HL11 through HL1k of the first multiplexer 151_1 and the first through kth horizontal bit lines HL21 through HL2k of the second multiplexer 151_2 and the first through kth horizontal bit lines HLj1 through HLjk of the jth multiplexer 151_j may extend in the first direction, but may be separated from each other to be not electrically connected to each other.

The connection relationship and operation of the first through kth horizontal bit lines HL21 through HL2k, first through kth vertical bit lines VL21 through VL2k, and the first through nth switching circuits SC21 through SC2n of the second multiplexer 151_2, and the connection relationship and operation of the first through kth horizontal bit lines HLj1 through HLjk, first through kth vertical bit lines VLj1 through VLjk, and the first through nth switching circuits SCj1 through SCjn of the jth multiplexer 151_j, may be the same as the connection relationship and operation of the first through kth horizontal bit lines HL11 through HL1k, the first through kth vertical bit lines VL11 through VL1k, and the first through nth switching circuits SC11 through SC1n of the first multiplexer 151_1.

FIG. 4A is a shift register 152 provided in a data bus according to an example embodiment, and FIG. 4B is a timing diagram of the shift register 152 according to an example embodiment.

In the data bus (150 of FIG. 2), the first through jth multiplexers 151_1 through 151_j may share the plurality of selection signals, for example, the first through nth selection signals CS[n:1], and the first through nth selection signals CS[n:1] may be generated by the shift register 152 in FIG. 4A.

Referring to FIG. 4A, the shift register 152 may include first through nth flip-flops FF1 through FFn. For example, the first through nth flip-flops FF1 through FFn may be implemented as D flip-flops.

The first through nth flip-flops FF1 through FFn may be connected to each other in series, and in response to a rising edge (or falling edge) of a clock signal CLK, may output an input signal (for example, an enable signal EN or an output signal of a previous flip-flop).

Referring to FIG. 4B, the first flip-flop FF1 may, in response to the rising edge of the clock signal CLK at a time point t1, output an on-level (for example, logic high) of the enable signal EN as the first selection signal CS[1]. The first flip-flop FF1 may maintain an on-level during a first cycle (t1 to t2) (for example, one cycle of the clock signal CLK).

A second flip-flop FF2 may, in response to the rising edge of the clock signal CLK at a time point t2, output an active level (for example, logic high) of the first selection signal CS[1] as the second selection signal CS[2]. In this case, the first flip-flop FF1 may, in response to the rising edge of the clock signal CLK, output an off-level (for example, logic low) of the enable signal EN as the first selection signal CS[1].

A third flip-flop may, in response to the rising edge of the clock signal CLK at a time point t3, output an active level (for example, logic high) of the second selection signal CS[2] as the third selection signal CS[3]. The second flip-flop FF2 may, in response to the rising edge of the clock signal CLK, output an off-level (for example, logic low) of the first selection signal CS[1] as the second selection signal CS[2].

In this manner, the first through nth flip-flops FF1 through FFn may be connected to each other in series to shift the enable signal EN, and may output the shifted enable signal EN as first through nth selection signals CS[1] through CS[n]. Accordingly, the first through nth selection signals CS[1] through CS[n] may sequentially have on-levels during first through nth cycles (for example, from the time point t1 to the time point (tn+1).

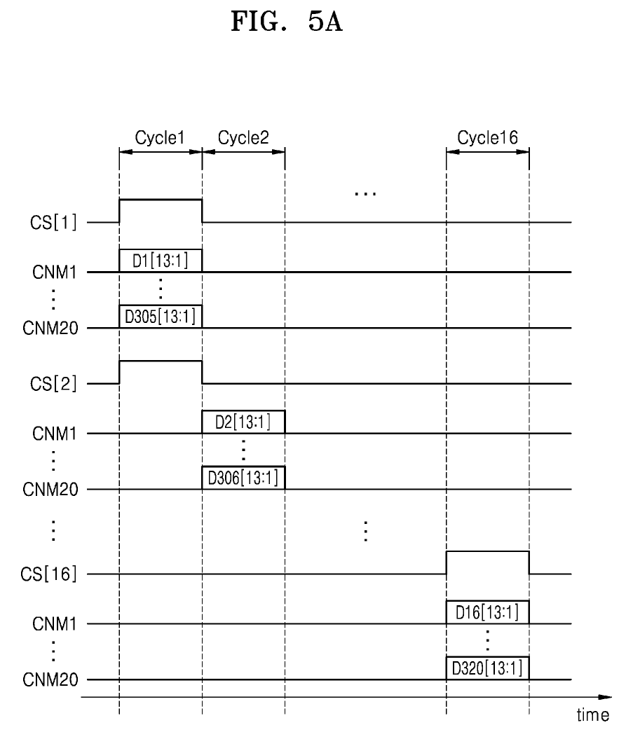

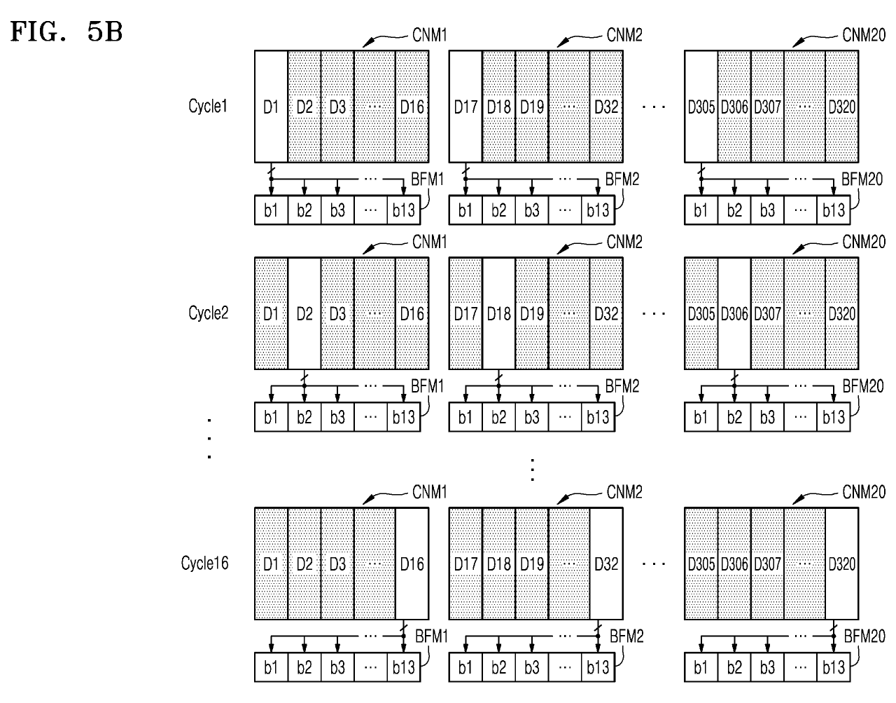

FIGS. 5A and 5B illustrate outputs of the data bus 150 according to example embodiments.

For example, it is assumed that the data bus (150 in FIG. 2) includes first through 20th channel memories CNM1 through CNM20, each of the first through 20th channel memories CNM1 through CNM20 includes 16 column memories, and the pixel data includes 13 bits. The plurality of multiplexers may include first through 20th multiplexers respectively corresponding to the first through 20th channel memories CNM1 through CNM20.

Referring to FIGS. 3, 5A, and 5B, twenty pieces of channel data output by the first through 20th channel memories CNM1 through CNM20 via the first through 20th multiplexers may be respectively stored in first through 20th buffer memories BFM1 through BFM20.

In a first cycle, the first selection signal CS[1] may be at the on-level. The first through 20th multiplexers may output pixel data stored in a first column memory from each of the first through 20th channel memories CNM1 through CNM20 according to the on-level of the first selection signal CS[1]. Each of twenty pieces of pixel data (for example, first pixel data D1, seventeenth pixel data D17, ..., 305th pixel data D305) may be output as channel data. First through thirteenth bits b1 through b13 of each of the first pixel data D1, the seventeenth pixel data D17, ..., the 305th pixel data D305 may be simultaneously output.

In a second cycle, the second selection signal CS[2] may be at the on-level. The first through 20th multiplexers may output pixel data stored in a second column memory from each of the first through 20th channel memories CNM1 through CNM20 according to the on-level of the second selection signal CS[2]. Each of twenty pieces of pixel data (for example, second pixel data D2, eighteenth pixel data D18, ..., 306th pixel data D306) may be output as channel data.

In a sixteenth cycle, a sixteenth selection signal CS may be at the on-level. The first through 20th multiplexers may output pixel data stored in a sixteenth column memory from each of the first through 20th channel memories CNM1 through CNM20 according to the on-level of the sixteenth selection signal CS. Each of twenty pieces of pixel data (for example, sixteenth pixel data D16, 32th pixel data D32, ..., 320th pixel data D320) may be output as channel data.

As a result, during the first through sixteenth cycles, the first through 320th pixel data stored in the first through 20th channel memories CNM1 through CNM20 may be output.

On the other hand, although twenty pieces of pixel data are output immediately after a selection signal is turned on in each cycle in FIG. 5A, the twenty pieces of pixel data may be output with a delay due to an RC delay of a signal line, a turn-on delay of switches SW, etc. However, the delay time may be less than or equal to one cycle.

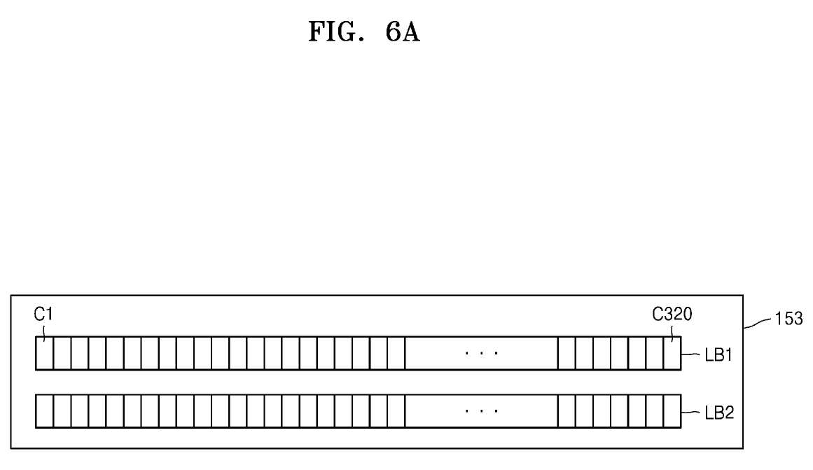

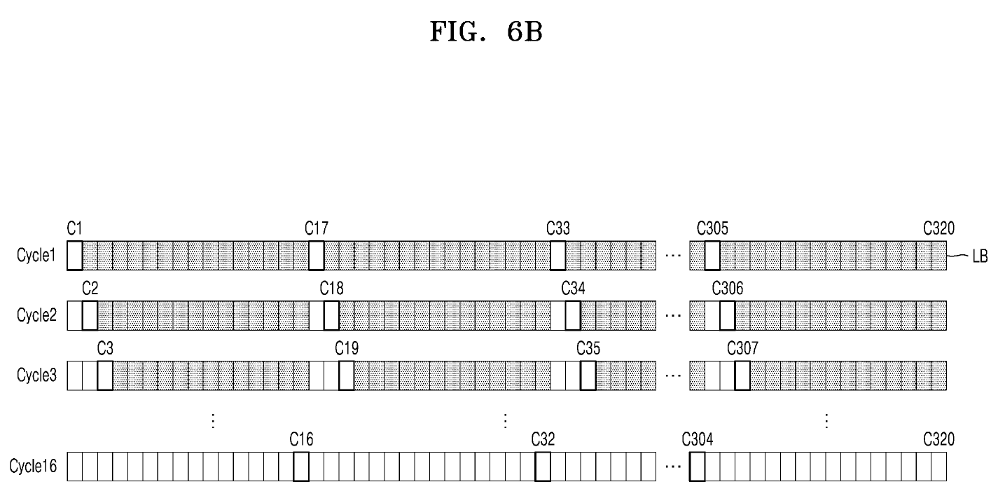

FIG. 6A is a data alignment circuit 153 provided in the data bus 150 according to an example embodiment, and FIG. 6B illustrates alignment of a plurality of pieces of pixel data on the data alignment circuit 153.

Referring to FIG. 6A, the data alignment circuit 153 may include a first line buffer LB1 and a second line buffer LB2, and each of the first line buffer LB1 and the second line buffer LB2 may include a plurality of columns (for example, first through 320th columns C1 through C320). The number of columns included in the first line buffer LB1 and the second line buffer LB2 may be changed. The first line buffer LB1 and the second line buffer LB2 may be implemented as memory devices, such as latches and volatile memories.

When pixel data are received from the first through jth multiplexers (151_1 through 151_j in FIG. 2) and stored in one of the first line buffer LB1 and the second line buffer LB2, the data stored in the other thereof may be output to the image signal processor (160 in FIG. 1).

Referring to FIG. 6B, a line buffer LB (for example, one of the first line buffer LB1 and the second line buffer LB2 of FIG. 6A) may include the plurality of columns (for example, first through 320th columns C1 through C320), and a plurality of pieces of channel data (for example, pixel data) may be received from the first through jth multiplexers (151_1 through 151_j in FIG. 2) and stored in some of the plurality of columns (for example, 20 columns) in each cycle. As an example, it is assumed that the plurality of multiplexers include first through 20th multiplexers, 20 pieces of channel data may be received, and the line buffer LB includes first through 320th columns C1 through C320.

In the first cycle, twenty pieces of channel data, for example, the first pixel data, the seventeenth pixel data, the 33rd pixel data, ..., the 305th pixel data, may be respectively stored in the first column C1, the seventeenth column C17, the 33^{rd} column C33, …, the 305th column C305. In the second cycle, the second pixel data, the eighteenth pixel data, the 34th pixel data, ..., the 306th pixel data may be respectively stored in the second column C2, the eighteenth column C18, the 34th column C34, …, the 306th column C306. In the third cycle, the third pixel data, the nineteenth pixel data, the 35th pixel data, ..., the 307th pixel data may be respectively stored in the third column C3, the nineteenth column C19, the 35th column C35, …, the 307th column C307. In the sixteenth cycle, the sixteenth pixel data, the 32nd pixel data, ..., the 304th pixel data, ..., the 320th pixel data may be respectively stored in the sixteenth column C16, the 32nd column C32, ..., the 304th column C304, …, the 320th column C320.

By receiving 20 pieces of pixel data in each cycle and storing the 20 pieces of pixel data in a corresponding column of the line buffer LB, in the first through sixteenth cycles, the plurality of pieces of pixel data, for example, 320 pieces of pixel data, may be stored and aligned in the line buffer LB.

The plurality of pieces of pixel data aligned with each other in the line buffer LB may be output in series to the image signal processor (160 in FIG. 1) in units of two or more pieces of adjacent pixel data.

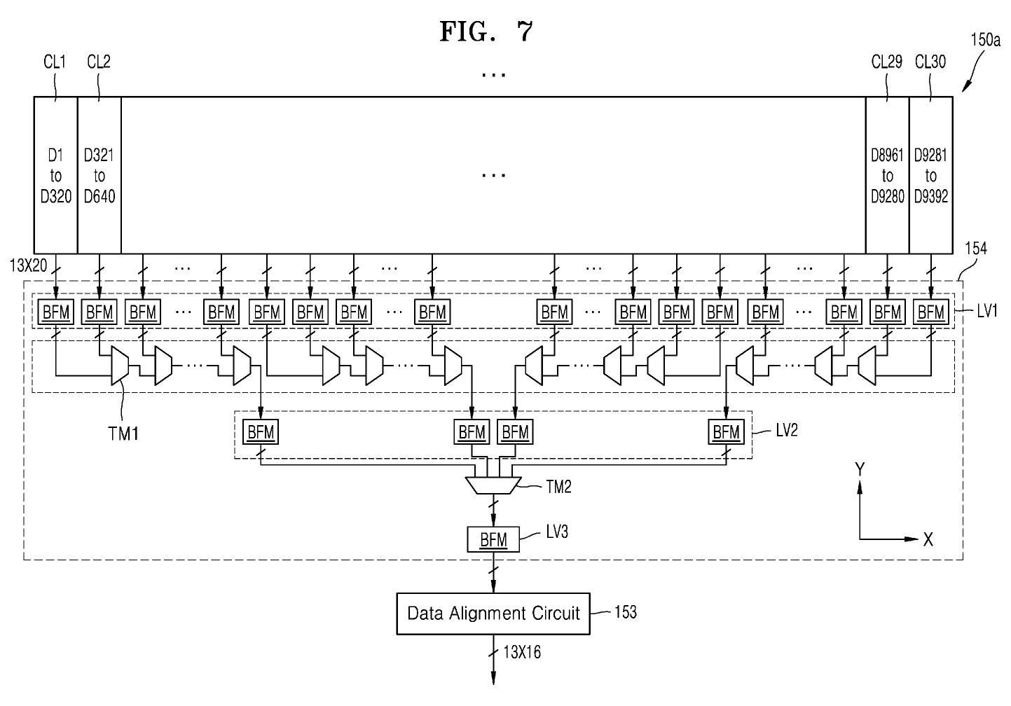

FIG. 7 is a data bus 150a according to an example embodiment.

Referring to FIG. 7, the data bus 150a may include a plurality of clusters (for example, first through 30th clusters CL1 through CL30), a transmission circuit 154, and the data alignment circuit 153. Each of a plurality of clusters may include a plurality of channel memories and a plurality of multiplexers respectively corresponding to the plurality of channel memories illustrated in FIG. 2, and because operations of the plurality of channel memories and the plurality of multiplexers are the same as those described with reference to FIGS. 2 through 5B, duplicate descriptions thereof are omitted.

As an example, it is assumed that the ADC circuit (130 in FIG. 1) includes 9392 ADCs (131 in FIG. 1), the data bus 150a includes the first through 30th clusters CL1 through CL30, each of the first through 30th clusters CL1 through CL30 includes first through 20th channel memories and first through 20th multiplexers, and each of the first through 20th channel memories includes first through 16th column memories. However, example embodiments are not limited to thereto, and the number of clusters, the number of channel memories and multiplexers, and the number of column memories included in the channel memory may vary depending on the number of ADCs (131 in FIG. 1).

Each of the first through 29th clusters CL1 through CL29 may receive and output different 320 pieces of pixel data among 9392 pieces of pixel data generated by the ADC circuit (130 in FIG. 1), but the 30th cluster CL30 may receive and output 112 pieces of pixel data. The first through 30th clusters CL1 through CL30 may simultaneously receive 9392 pieces of data from the ADC circuit (130 in FIG. 1) and store the 9392 pieces of data, and may output pixel data that has been stored during different cycles.

For example, the first cluster CL1 may receive the first through 320th pixel data D1 through D320 in parallel (simultaneously) and store the first through 320th pixel data D1 through D320 in the first through 20th channel memories, and may output the first through 320th pixel data D1 through D320 in series in units of 20 pieces of pixel data during 16 cycles (for example, first through 16th cycles). The second cluster CL2 may receive 321st through 640th pixel data D321 through D640 in parallel and store the 321st through 640th pixel data D321 through D640 in the first through 20th channel memories, and may output the 321st through 640th pixel data D321 through D640 in series during the next 16 cycles (for example, 17th through 32nd cycles). The 29th cluster CL29 may receive 8961st through 9280th pixel data D8961 through D9280 and store the 8961st through 9280th pixel data D8961 through D9280 in the first through 20th channel memories, and may output the 8961st through 9280th pixel data D8961 through D9280 in series during the next 16 cycles (for example, 449th through 464th cycles). The 30th cluster CL30 may receive 9281st through 9392nd pixel data D9281 through D9392 and store the 9281st through 9392nd pixel data D9281 through D9392 in the first through 20th channel memories, and may output the 9281st through 9392nd pixel data D9281 through D9392 in series during last 16 cycles (for example, 465th through 480th cycles).

The transmission circuit 154 may include a plurality of buffer memories BFM, and a plurality of transmission multiplexers, for example, a plurality of first transmission multiplexers TM1 and second transmission multiplexers TM2. The plurality of buffer memories BFM, the plurality of first transmission multiplexers TM1, and the second transmission multiplexer TM2 may be provided to completely transmit data output by the first through 30th clusters CL1 through CL30 to the data alignment circuit 153.

As illustrated in FIG. 7, the first through 30th clusters CL1 through CL30 are arranged side-by-side in the first direction (for example, the X-axis direction), and as illustrated in FIG. 2, each of the first through 30th clusters CL1 through CL30 includes 320 column memories arranged side-by-side in the first direction. In this regard, the length in the first direction of the data bus 150a may be considerably long. When data output by each cluster is transmitted to the data alignment circuit 153 via a transmission line, without the plurality of buffer memories BFM, the plurality of first transmission multiplexers TM1, and the second transmission multiplexer TM2, due to noise imported into the RC delay of the transmission line or the transmission line, data output by each cluster may not be fully provided to the data alignment circuit 153. In particular, data output by clusters at the edge among the first through 30th clusters CL1 through CL30 may not be fully provided to the data alignment circuit 153.

Even though the level of the received data (for example, logic high or logic low) somewhat decreases or increases, the plurality of buffer memories BFM, the plurality of first transmission multiplexers TM1, and the second transmission multiplexer TM2 may restore a level of the received data. Accordingly, data output by each cluster may be fully transmitted to the data alignment circuit 153 without changing the data value.

Because respective clusters simultaneously output 20 pieces of channel data, and the channel data (pixel data) includes 13 bits, respective input lines and output lines of the plurality of buffer memories BFM, the plurality of first transmission multiplexers TM1, and second transmission multiplexers TM2 may include 260 lines (i.e., 260=13×20).

After twenty pieces of channel data (for example, 20 pieces of pixel data) output by the first through 30th clusters CL1 through CL30 are stored in the buffer memory BFM of a first level LV1, in the next cycle, the twenty pieces of channel data may be stored in the buffer memory BFM of a second level LV2 via the plurality of first transmission multiplexers TM1. Thereafter, in the next cycle, the twenty pieces of channel data may be stored in the buffer memory BFM of a third level LV3 via the second transmission multiplexer TM2, and in the following cycle, may be provided to the data alignment circuit 153. For example, channel data output by each of the first through 30th clusters CL1 through CL30 may be provided to the data alignment circuit 153 during three cycles. However, example embodiments are not limited thereto. The numbers of levels of the plurality of buffer memories BFM, the plurality of first transmission multiplexers TM1, and the second transmission multiplexer TM2 may be changed, and the number of cycles required to transmit data output by the first through 30th clusters CL1 through CL30 to the data alignment circuit 153 may also be changed.

In an example embodiment, the first and second transmission multiplexers TM1 and TM2 may be replaced with logic gates, for example, OR gates. In this case, a logic low input signal may be applied to an input line, to which data are not transmitted, among the input lines. Accordingly, the OR gate may output the received data.

As illustrated in FIG. 6A, the data alignment circuit 153 may include the first line buffer LB1 and the second line buffer LB2, and each line buffer may store channel data received during 16 cycles by one cluster, for example, 320 pieces of pixel data. Each line buffer may include 320 columns, and each column may include 13 latches to store 13 bits. Accordingly, each line buffer of the data alignment circuit 153 may include 4,160 (i.e., 4,160=13×20×16) latches. However, example embodiments are not limited thereto, and the number of pieces of pixel data and the number of latches stored in the data alignment circuit 153 may be changed.

The data alignment circuit 153 may align 320 pieces of pixel data received in series from each cluster as described with reference to FIG. 6B, and output the aligned pixel data to the image signal processor (160 of FIG. 1) in units of two or more pieces of adjacent pixel data. In an example embodiment, the data alignment circuit 153 may output in series a plurality of pieces of pixel data in units of 16 pieces of pixel data via 208 (i.e., 208=13×16) transmission lines. However, example embodiments are not limited thereto, and the number of pieces of pixel data simultaneously transmitted may be changed.

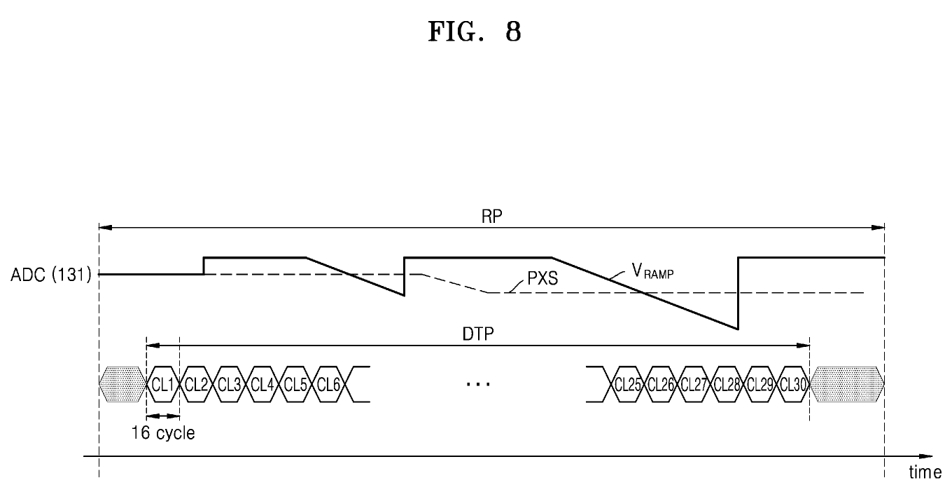

FIG. 8 is a timing diagram illustrating data output of the data bus 150 according to an example embodiment. FIG. 8 illustrates data outputs of a plurality of clusters of the data bus 150a of FIG. 7.

Referring to FIGS. 1 and 8, a plurality of rows of the pixel array 110 may be read out during a plurality of readout periods, and the plurality of pixel signals PXS may be read out from one row of pixels during one readout period RP.

The ADC circuit 130 may receive a plurality of pixel signals PXS from one row of pixels during one readout period RP, and convert the plurality of pixel signals PXS into a plurality of pieces of pixel data. The plurality of ADCs 131 may generate the plurality of pieces of pixel data by converting the pixel signals PXS that are received in parallel (simultaneously) into the pixel data. The comparator 132 may compare the pixel signal PXS to the ramp signal V_{RAMP} to generate a comparison result signal, and the counter 133 may generate the pixel data based on the comparison result signal. The plurality of pieces of pixel data may be stored in the plurality of clusters of the data bus 150a, for example, the plurality of channel memories provided in each of the first through 30th clusters CL1 through CL30.

In the next readout period RP, the first through 30th clusters CL1 through CL30 may transmit the plurality of pieces of pixel data to the data alignment circuit 153. One cluster may output 320 pieces of pixel data during 16 cycles (for example, 16 cycles of a clock signal applied to the data bus 150a). Each of the first through 20th channel memories may store 16 pieces of pixel data, and may output one piece of pixel data each cycle. Twenty pieces of pixel data may be output each cycle, and 320 pieces of pixel data may be output in 16 cycles.

Each of the first through 30th clusters CL1 through CL30 may sequentially output pieces of pixel data, and may output the plurality of pieces of pixel data during the data transmission period DTP (for example, 480 (i.e., 480=16×30) cycles). The length of the data transmission period DTP may be less than the length of one readout period RP.

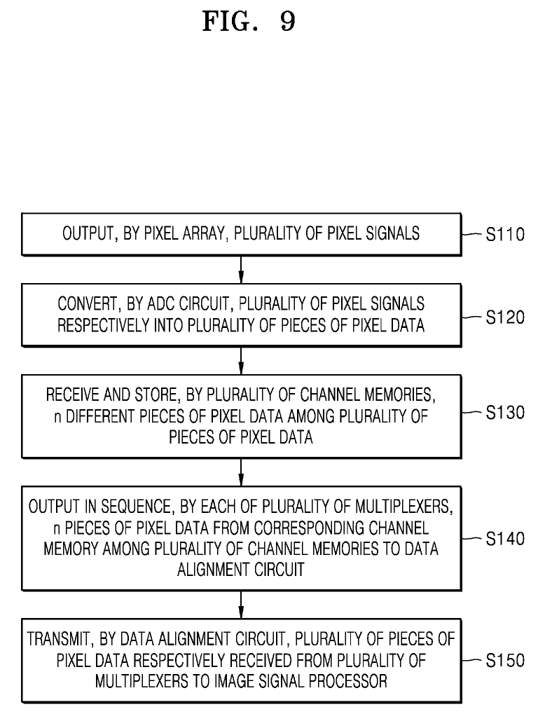

FIG. 9 is a flowchart of a method of operating the image sensor 100, according to an example embodiment. The method of operating an image sensor of FIG. 9 may be performed by the image sensor 100 of FIG. 1.

Referring to FIGS. 1, 2, and 9, the pixel array 110 may output the plurality of pixel signals PXS corresponding to one row (S110). The pixels PX arranged on a row selected by control signals received from the row driver 120 among the plurality of pixels PX of the pixel array 110 may output the plurality of pixel signals PXS via the plurality of column lines CL.

The ADC circuit 130 may convert the plurality of pixel signals PXS into the plurality of pieces of pixel data (S120). The ADC circuit 130 may include the plurality of ADCs 131, and the plurality of ADCs 131 may convert a plurality of pixel signals PXS into a plurality of pieces of pixel data in parallel (simultaneously).

The first through jth channel memories CNM1 through CNMj may receive n different pieces of pixel data from among the plurality of pieces of pixel data (S130). N pieces of pixel data stored in the channel memory may be received from n adjacent ADCs 131 among the plurality of ADCs 131. Each of the plurality of channel memories CNM1 through CNMj may temporarily store the received n pieces of pixel data.

Each of the first through jth multiplexers 151_1 through 151_j may sequentially (one by one continuously) output n pieces of pixel data from the corresponding channel memory among the plurality of channel memories CNM1 through CNMj to the data alignment circuit 153 (S140). The first through jth multiplexers 151_1 through 151_j may share a plurality of selection signals, for example, n selection signals, and may simultaneously operate according to n selection signals. Each of the first through jth multiplexers 151_1 through 151_j may sequentially select and output n pieces of pixel data during n cycles based on n selection signals. Each of the first through jth multiplexers 151_1 through 151_j may simultaneously output a plurality of bits of the selected pixel data. When the first through jth multiplexers 151_1 through 151_j include 20 multiplexers, 20 pieces of pixel data may be transmitted to the data alignment circuit 153 in one cycle.

In an example embodiment, the n selection signals may be generated by the shift register (152 in FIG. 4A) based on the enable signal and the clock signal CLK. In an example embodiment, the n selection signals may be provided to the timing controller 170.

The data alignment circuit 153 may transmit the plurality of pieces of pixel data received from the first through jth multiplexers 151_1 through 151_j to the image signal processor 160 (S150). The data alignment circuit 153 may align the plurality of pieces of pixel data received from the first through jth multiplexers 151_1 through 151_j. As described with reference to FIG. 6B, the data alignment circuit 153 may align the plurality of pieces of pixel data, by storing the received pixel data on a corresponding column among the plurality of columns of the line buffer LB. The data alignment circuit 153 may transmit the aligned plurality of pieces of pixel data to the image signal processor 160. The data alignment circuit 153 may sequentially transmit the plurality of pieces of pixel data to the image signal processor 160 in units of two or more pieces of adjacent pixel data.

The image signal processor 160 may perform an image processing operation on image data including a plurality of pieces of pixel data, and transmit the image-processed image data to the outside, for example, to an external processor.

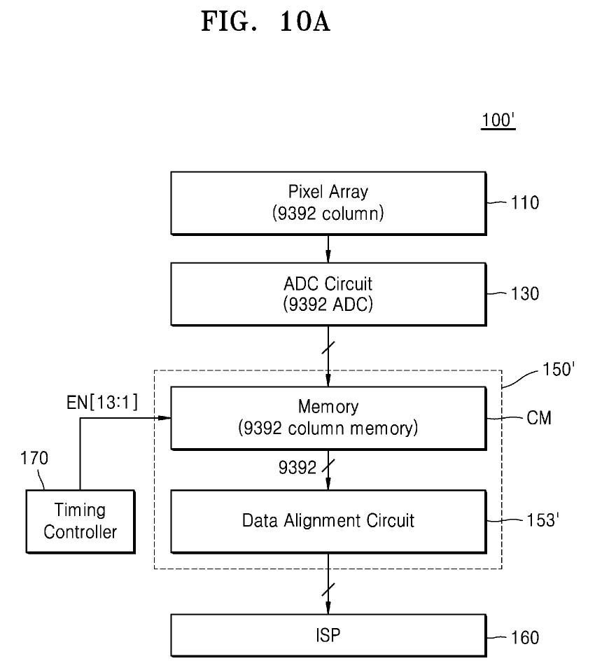

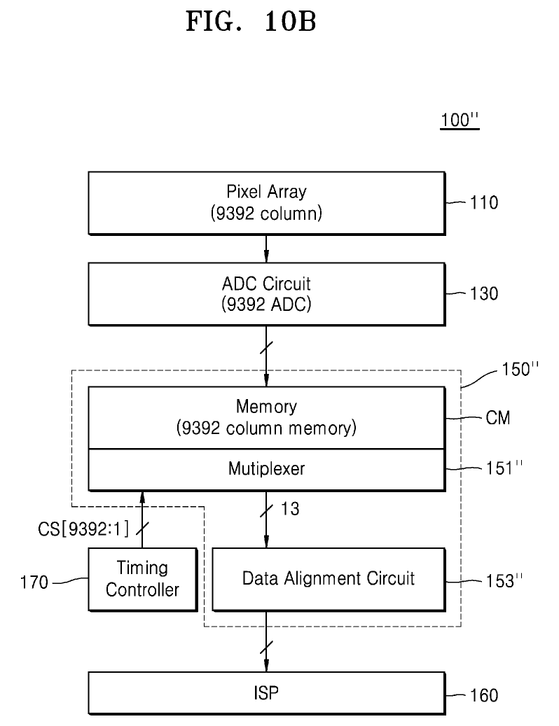

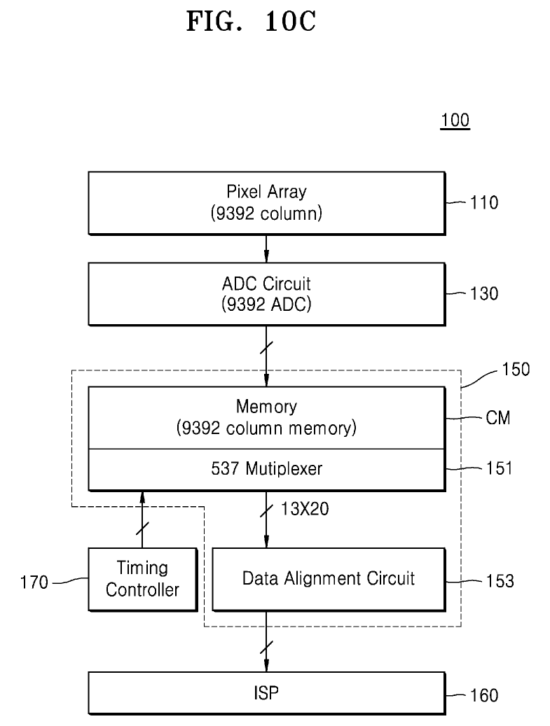

FIGS. 10A and 10B are image sensors 100’ and 100” according to comparative examples, respectively, and FIG. 10C is the image sensor 100 according to an example embodiment. Data buses 150’ and 150” according to the comparative examples and the data bus 150 according to an example embodiment are described with reference to FIGS. 10A, 10B AND 10C. It is assumed that the pixel array 110 includes 9392 columns and the ADC circuit 130 includes 9392 ADCs.

Referring to FIG. 10A, in the image sensor 100’ according to a first comparative example, the data bus 150’ may include 9392 column memories CM and a data alignment circuit 153’, and 9392 pieces of pixel data stored in 9392 column memories CM may be transmitted to the data alignment circuit 153’ in parallel (simultaneously) via 9392 transmission lines. In this case, a plurality of bits of pixel data, for example, first through 13th bits, may be transmitted to the data alignment circuit 153’ in series via the same transmission line.

The timing controller 170 may provide an enable signal EN[13:1] for selecting a bit to be transmitted to the data bus 150’. In the first cycle, the first bit of each of 9392 pieces of pixel data may be transmitted to the data alignment circuit 153’ according to the on-level of a first enable signal EN[1], in the second cycle, the second bit of each of 9392 pieces of pixel data may be transmitted to the data alignment circuit 153’ according to the on-level of a second enable signal EN[2], and in the thirteenth cycle, the 13th bit of each of 9392 pieces of pixel data may be transmitted to the data alignment circuit 153’ according to the on-level of a 13th enable signal EN. During 13 cycles, 13 bits of each of 9392 pieces of pixel data may be transmitted to the data alignment circuit 153’.

In the image sensor 100’ of FIG. 10A, because 9392 pieces of pixel data are provided to the data alignment circuit 153’ in parallel, although the number of input lines of the data bus 150’, to which input signals, for example, the enable signal EN[13:1] are transmitted, may be small, 9392 transmission lines may be connected between the 9392 column memories CM and the data alignment circuit 153’ so that the number of transmission lines may be significant. When the image sensor 100’ is implemented in a semiconductor chip, the area of the area (routing area) in which 9392 transmission lines are arranged and routed on the layout may be a large proportion of the total area.

In addition, after all of the first through 13th bits of 9392 pieces of pixel data are received, the data alignment circuit 153’ may transmit data to the image signal processor 160 in units of two or more pieces of adjacent pixel data. To this end, the data alignment circuit 153’ may include a line buffer having a size capable of storing the 9392 pieces of pixel data. For example, the data alignment circuit 153’ may include a line buffer including 122096 (i.e., 122096 =9392×13) latches. The size of the data alignment circuit 153’ may be large.

Referring to FIG. 10B, in the image sensor 100” according to a second comparative example, a data bus 150” may include 9392 column memories CM, a multiplexer 151”, and a data alignment circuit 153”, and the 9392 pieces of pixel data stored in the 9392 column memories CM may be transmitted to the data alignment circuit 153” in serial (sequentially) via 13 transmission lines. In this case, a plurality of bits of pixel data, for example, first through 13th bits, may be transmitted to the data alignment circuit 153’’ in series via the thirteen transmission lines.

The timing controller 170 may provide selection signals CS[9392:1] for selecting pixel data to be transmitted to the multiplexer 151”. The timing controller 170 may generate first through 9392nd selection signals CS[1] through CS for selecting first through 9392nd pixel data, and may provide the first through 9392nd selection signals CS[1] through CS to the multiplexer 151”.

The multiplexer 151” may transmit the 9392 pieces of pixel data to the data alignment circuit 153” in series according to the selection signals CS[9392:1] during the first through 9392nd cycles.

In the image sensor 100” of FIG. 10B, because 9392 pieces of pixel data are provided to the data alignment circuit 153” in series, the number of transmission lines arranged in the 9392 column memories CM and the data alignment circuit 153” may be reduced to 13. However, to select the 9392 pieces of pixel data sequentially, and transmit the selection signals CS[9392:1] provided by the timing controller 170 to the multiplexer 151”, 9392 input lines may be connected between the timing controller 170 and the multiplexer 151”. When the number of input lines is significant, and the image sensor 100” is implemented in a semiconductor chip, the area of the area in which the 9392 input lines are arranged and routed on the layout may be a large proportion of the total area.

In the image sensor 100 of FIG. 10C, which is consistent with example embodiments, the data bus 150 may include 9392 column memories CM, 537 multiplexers 151, and data alignment circuits 153, and j multiplexers 151 may operate while sharing selection signals. The multiplexer 151 may sequentially select and output n, for example, 16, pieces of pixel data.

For example, when 20 multiplexers 151 operate while sharing the selection signals, the 9392 pieces of pixel data stored in the 9392 column memories CM may be sequentially selected by 20 pieces by the 537 multiplexers 151, and transmitted to the data alignment circuit 153. In this case, a plurality of bits of pixel data, for example, first through 13th bits, may be transmitted to the data alignment circuit 153 in series via the thirteen transmission lines. Accordingly, the 9392 pieces of pixel data may be sequentially selected by 20 pieces, and transmitted in series (sequentially) to the data alignment circuit 153 via 260 (i.e., 260=13×20) transmission lines.

The timing controller 170 may provide control signals for selecting pixel data to be transmitted, for example, the enable signal EN and the clock signal CLK, to the data bus 150. The data bus 150 may generate a plurality of selection signals based on the enable signal EN and the clock signal CLK. Alternatively, the timing controller 170 may generate a plurality of selection signals and provide the plurality of selection signals to the data bus 150. Because the selection signals are shared in units of 20 multiplexers 151, the number of selection signals may be 480 or less.

The number of input lines connected between the data bus 150 and the timing controller 170 may be two or more, up to a maximum of 480, and the number of transmission lines connected between the data alignment circuit 153 and the data bus 150 may be 260 (i.e., 260=13×20).

The number of input lines and transmission lines connected to the data bus 150 may be 262 (i.e., 262=260+2) to 740 (i.e., 740=260+480), which is less than the number of input lines and transmission lines connected to the data buses 150’ and 150” in the image sensors 100’ and 100” of FIGS. 10A and 10B, respectively. Accordingly, when the image sensor 100’ is implemented in a semiconductor chip, a ratio of the area of the area, in which input lines are arranged and routed on a layout, to the entire area may be reduced.

In addition, because the data alignment circuit 153 simultaneously receives the plurality of bits of pixel data, unlike the data alignment circuit 153’ of FIG. 10A, there may be no need to store all of the 9392 pieces of pixel data. The data alignment circuit 153 may include a line buffer having a size to store a certain number of pieces of adjacent pixel data (for example, 320 pieces of pixel data). Accordingly, the size of the data alignment circuit 153 may be reduced.

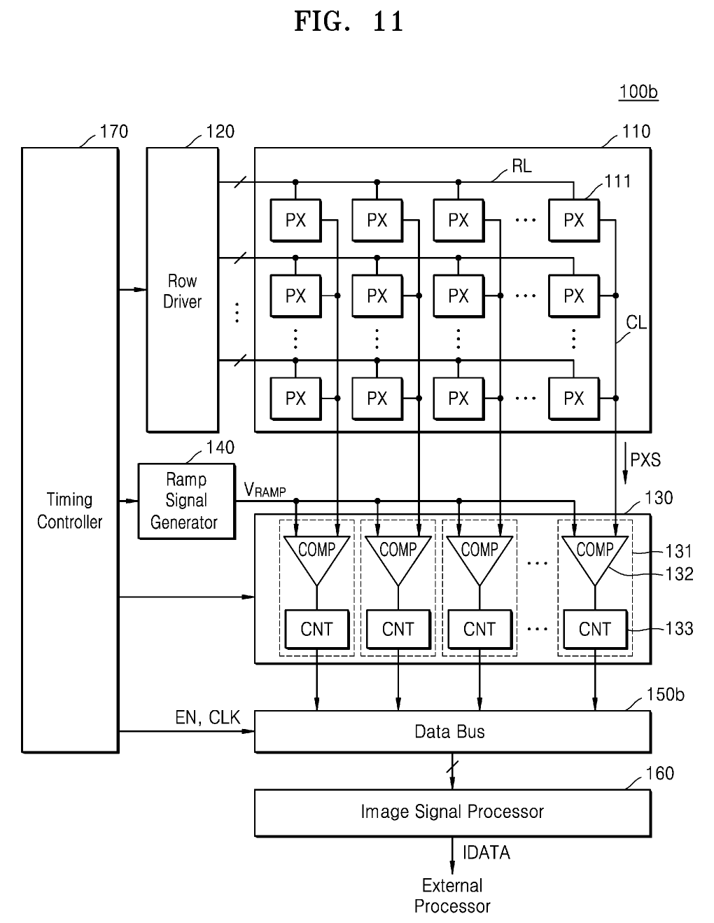

FIG. 11 is an image sensor 100b according to an example embodiment.

Referring to FIG. 11, the image sensor 100b may include the pixel array 110, the row driver 120, the ADC circuit 130, the ramp signal generator 140, a data bus 150b, the image signal processor 160, and the timing controller 170.

Because the operations of the pixel array 110, the row driver 120, the analog-to-digital converter circuit 130, the ramp signal generator 140, the image signal processor 160, and the timing controller 170 are the same as those described with reference to FIG. 1, duplicate descriptions thereof are omitted.

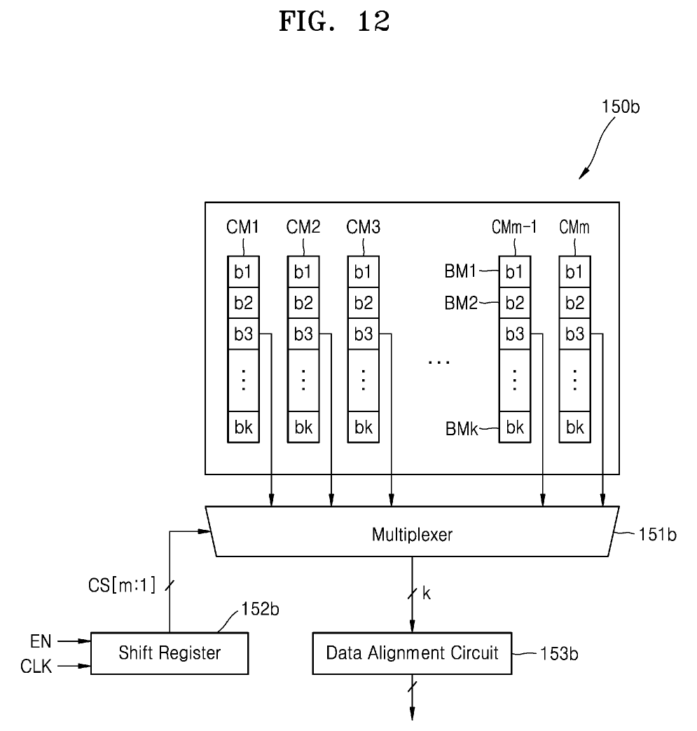

In an example embodiment, the data bus 150b may receive the enable signal EN and the clock signal CLK from the timing controller 170, and a shift register (152b of FIG. 12 provided in the data bus 150b may generate a plurality of selection signals. The data bus 150b may receive the enable signal EN and the clock signal CLK from the timing controller 170 via two input lines.

FIG. 12 is the data bus 150b according to an example embodiment.

Referring to FIG. 12, the data bus 150b may include a plurality of column memories, such as first through mth column memories CM1 through CMm (where m is an integer of 16 or more), a multiplexer 151b, a shift register 152b, and a data alignment circuit 153b.

Each column memory may include a plurality of bit memories, for example, first through kth bit memories BM1 through BMk, and the first through kth bit memories BM1 through BMk may respectively store first through kth bits b1 through bk of pixel data.

The shift register 152b may generate a plurality of selection signals, for example, first through mth selection signals CS[m:1] based on the enable signal EN and the clock signal CLK. The enable signal EN and the clock signal CLK may be provided by the timing controller (170 in FIG. 11).

The multiplexer 151b may select first through mth bit data stored in the first through mth column memories CM1 through CMm one by one based on the first through mth selection signals CS[m:1], and output the selected pixel data to the data alignment circuit 153b. The multiplexer 151b may simultaneously output first through kth bits b1 through bk of pixel data via k transmission lines.

The data alignment circuit 153b may align a plurality of pieces of pixel data received, and may output the aligned plurality of pieces of pixel data in series in units of one or more pieces of pixel data to the image signal processor (160 in FIG. 11).

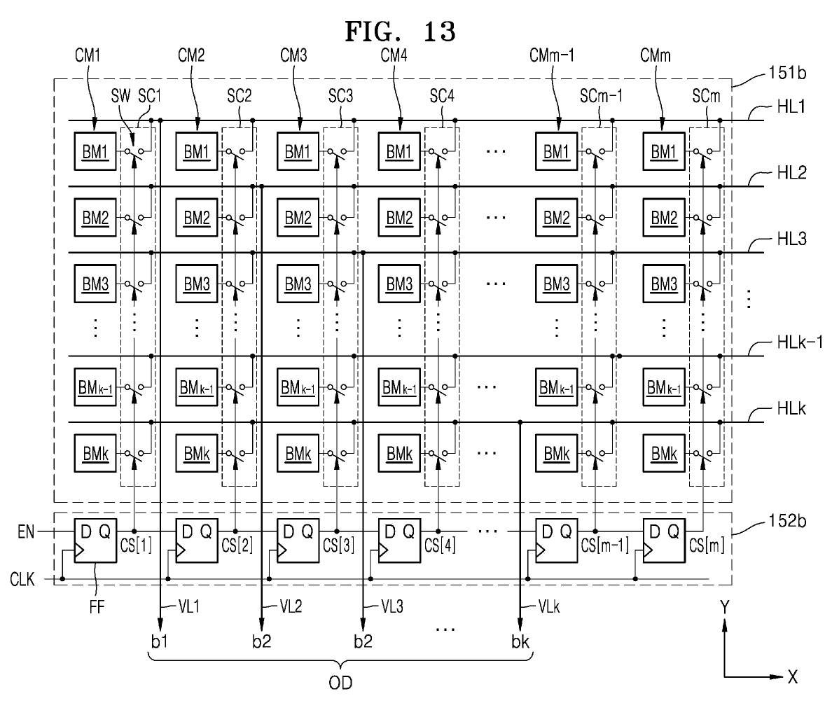

FIG. 13 is a circuit diagram of a multiplexer 151b and a shift register 152b provided in a data bus according to an example embodiment. FIG. 13 illustrates the multiplexer 151b and the shift register 152b in FIG. 12.

Referring to FIGS. 12 and 13, the multiplexer 151b may include first through kth horizontal bit lines HL1 through HLk, first through kth vertical bit lines VL1 through VLk, and first through mth switching circuits SC11 through SC1m. The number of horizontal bit lines and vertical bit lines may be equal to the number of bits of pixel data, and the number of switching circuits may be equal to the number of column memories.

The first through kth horizontal bit lines HL1 through HLk may extend in the first direction (for example, the X-axis direction), and may be arranged side-by-side (in parallel) between the plurality of first bit memories BM1 through the plurality of kth bit memories BMk of the first through mth column memories CM1 through CMm in the second direction (for example, the Y-axis direction).

The first through kth vertical bit lines VL1 through VLk may extend in the second direction, and may be arranged side-by-side in the first direction. The first through kth vertical bit lines VL1 through VLk may be electrically connected to the first through kth horizontal bit lines HL1 through HLk, respectively.

The first through mth switching circuits SC1 through SCm may respectively correspond to the first through mth column memories CM1 through CMm. The first through mth switching circuits SC1 through SCm may include a plurality of switches SW (for example, k switches) respectively connected between the first through kth bit memories BM1 through BMk and the first through kth horizontal bit lines HL1 through HLk of the column memory. Each of the first through mth switching circuits SC1 through SCm may be turned on and turned off according to a corresponding selection signal of first through mth selection signals CS[1] through CS[m].

The shift register 152b may include a plurality of flip-flops (for example, m flip-flops), the plurality of flip-flops may be connected in series, and may output an input signal (for example, an enable signal EN) or an output signal of a previous flip-flop as the first through mth selection signals CS[1] through CS[m] in response to the rising edge (or falling edge) of the clock signal CLK. Because the configuration and operation of the shift register 152b are substantially the same as those of the shift register 152 described with reference to FIGS. 4A and 4B, detailed descriptions thereof are omitted.

The first through mth switching circuits SC1 through SCm may be turned on according to an on-level of the corresponding selection signal among the first through mth selection signals CS[1] through CS[m], and provide the first through kth bits b1 through bk of the corresponding column memory to the first through kth horizontal bit lines HL1 through HLk. The first through kth horizontal bit lines HL1 through HLk may provide the first through kth bits b1 through bk to the first through kth vertical bit lines VL1 through VLk, and the first through kth bits b1 through bk may be output via the first through kth vertical bit lines VL1 through VLk.

After output data OD (for example, selected and outputted pixel data) is temporarily stored in a buffer memory, the output data OD may be transmitted to the data alignment circuit 153b. The output data OD may be transmitted to the data alignment circuit 153b via k transmission lines.

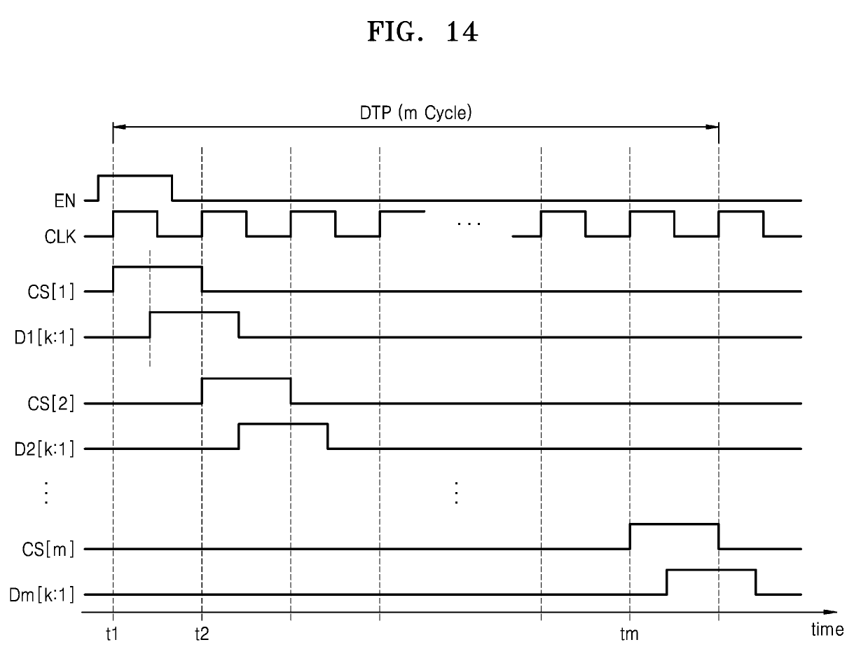

FIG. 14 is a timing diagram of the shift register 152b and the multiplexer 151b provided in a data bus according to an example embodiment. FIG. 14 illustrates input signals and output signals of the shift register 152b of FIG. 13, and the output data OD output from the multiplexer 151b.

Referring to FIGS. 13 and 14, the enable signal EN may be shifted and output from each flip-flop FF in response to the rising edge of the clock signal CLK.

At the time point t1, the first selection signal CS[1] may transition from an off-level (logic low) to an on-level (logic high). Other selection signals, for example, the second through mth selection signals CS[2] through CS[m] may be at an off-level. The switches SW provided on the first switching circuit SC1 among first through mth switching circuits SC1 through SCm may be turned on according to the on level of the first selection signal CS[1], and may respectively output first through kth bits D1[k:1] of the first pixel data stored in the first column memory (CM1 in FIG. 13). After a selection signal, for example, the first selection signal CS[1], is transitioned to an on-level due to the RC delay of a signal line and the turn-on delay of the switches SW, pixel data, for example, the first through kth bits D1[k:1] of the first pixel data, may be delayed and output.

At the time point t2, the second selection signal CS[2] may be transitioned from an off-level (logic low) to an on-level (logic high). All other selection signals may be at an off- level. The switches SW provided on the second switching circuit SC2 among first through mth switching circuits SC1 through SCm may be turned on according to an on-level of the second selection signal CS[2], and may respectively output first through kth bits D2[k:1] of the second pixel data stored in the second column memory (CM2 in FIG. 13).

At the time point t2, the second selection signal CS[2] may be transitioned from an off-level to an on-level. All other selection signals may be at an off-level. The switches SW provided on the second switching circuit SC2 among first through mth switching circuits SC1 through SCm may be turned on according to an on-level of the second selection signal CS[2], and may respectively output first through kth bits D2[k:1] of the second pixel data.

An operation of outputting corresponding pixel data according to the selection signal of an on-level may be repeated. At a time point tm, the mth selection signal CS[m] may be transitioned from an off-level to an on-level. All other selection signals may be at an off-level. The switches SW provided on the mth switching circuit SCm among first through mth switching circuits SC1 through SCm may be turned on according to an on-level of the mth selection signal CS[m], and may respectively output first through kth bits Dm[k:1] of the mth pixel data.

In this manner, the multiplexer 151b may output in series a plurality of pieces of pixel data, for example, first through mth pixel data, during a data transmission period DTP including the m cycles.

The data bus 150b described with reference to FIGS. 11 through 14 may receive the enable signal EN and the clock signal CLK from the timing controller 170 via two input lines, and output in series a plurality of pieces of pixel data via k transmission lines. Accordingly, the number of input lines and transmission lines of the data bus 150b may be reduced, the signal congestion level may be reduced, and the area of the routing area may be reduced.

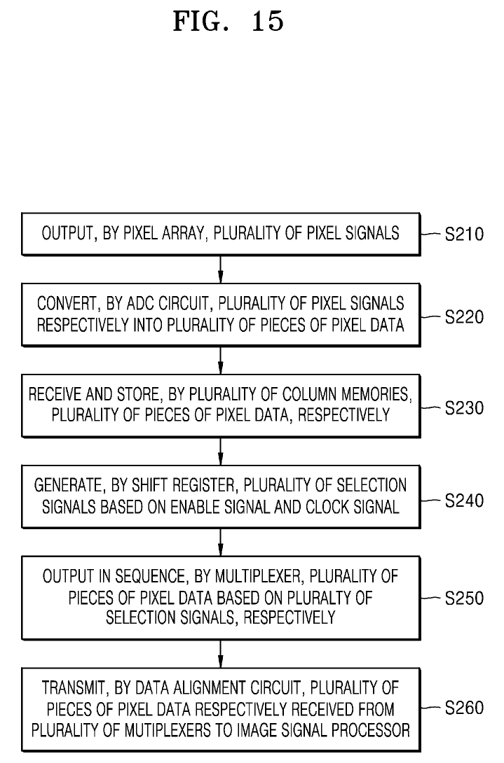

FIG. 15 is a flowchart of a method of operating the image sensor 100b, according to an example embodiment. The method of operating an image sensor may be performed by using the image sensor 100b of FIG. 11.

Referring to FIGS. 11, 13, and 15, the pixel array 110 may output the plurality of pixel signals PXS corresponding to one row (S210). The plurality of ADCs 131 provided on the ADC circuit 130 may convert a plurality of pixel signals PXS into a plurality of pieces of pixel data (S220). The plurality of column memories CM1 through CMm may receive and store a plurality of pieces of pixel data (S230). The plurality of column memories CM1 through CMm may receive a plurality of pieces of pixel data from the plurality of ADCs 131, and store pixel data received by each of the plurality of column memories CM1 through CMm.

The shift register 152b may generate the first through mth selection signals CS[m:1] based on the enable signal EN and the clock signal CLK received from the timing controller 170 (S240).

The multiplexer 151b may sequentially select the plurality of pieces of pixel data stored in the plurality of column memories CM1 through CMm based on the first through mth selection signals CS[m:1], and may output the selected pixel data to the data alignment circuit 153b (S250). For example, the multiplexer 151b may output m pieces of pixel data during m cycles.

The data alignment circuit 153b may transmit the plurality of pieces of pixel data received from the multiplexer 151b to the image signal processor 160 (S260). The data alignment circuit 153b may align a plurality of pieces of pixel data received from the multiplexer 151b, and sequentially transmit the plurality of aligned pixel data to the image signal processor 160 in units of two or more pieces of adjacent pixel data.

The image signal processor 160 may perform an image processing operation on image data including a plurality of pieces of pixel data, and transmit the image-processed image data to the outside, for example, to an external processor.

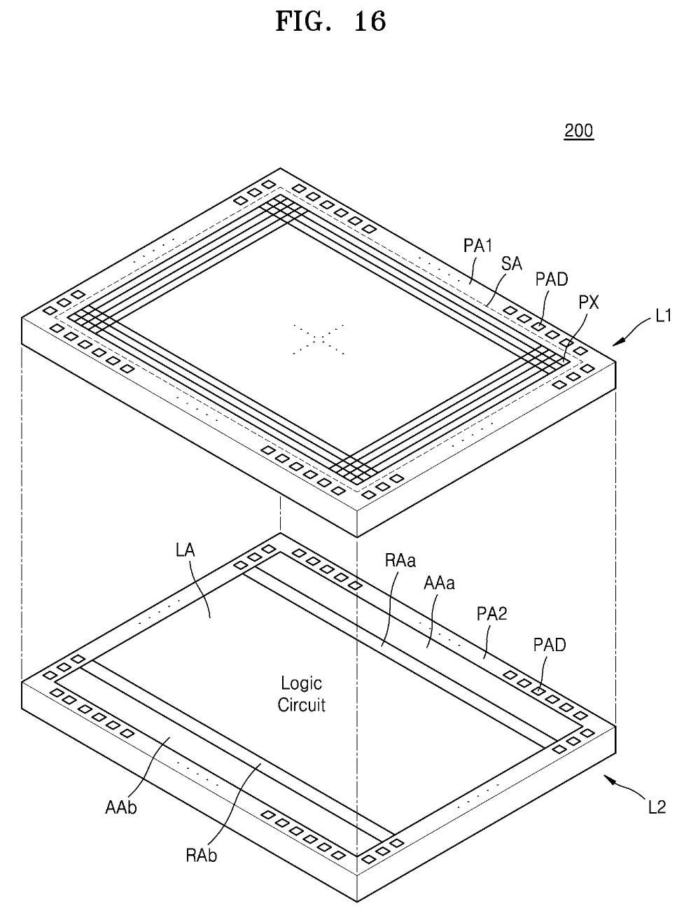

FIG. 16 is a stack structure of an image sensor 200 according to an example embodiment.

Referring to FIG. 16, the image sensor 200 may include a plurality of layers to be stacked, for example, a first layer L1 and a second layer L2. In an example embodiment, the first layer L1 and the second layer L2 may be formed on a semiconductor substrate or a semiconductor chip. The image sensor 100 may include a semiconductor chip or a semiconductor module. The image sensor 100 of FIG. 1 and/or the image sensor 100b of FIG. 11 may be applied as the image sensor 200.

The first layer L1 may include a sensing area SA and a first pad area PA1 on which a plurality of pixels PX of the pixel array (110 in FIG. 1) are arranged. A plurality of pads PAD may be arranged in the first pad area PA1, and the plurality of pads PAD of the first layer L1 may be respectively connected to the plurality of pads PAD of a second pad area PA2 of the second layer L2 via a via, a contact, etc.

The row driver (120 in FIG. 1), the ADC circuit 130, the ramp signal generator 140, the data bus 150, an image signal processor 160, and the timing controller 170 of the image sensor 100 may be formed in the second layer L2.

A logic circuit (or a digital circuit) of the image sensor 100, for example, the image signal processor 160 and the timing controller 170 may be formed in the logic area LA. The ADC circuit 130 may be formed in analog areas AAa and AAb arranged on both sides of the second layer L2. The analog areas AAa and AAb may be arranged between the logic area LA and the second pad area PA2. Routing areas RAa and RAb may be arranged between the analog areas AAa and AAb and the logic area LA, and the data buses 150 and 150b (or input lines and transmission lines of the data buses 150 and 150b) may be formed in the routing areas RAa and RAb. As described with reference to FIG. 10C, in the image sensor 100 according to an example embodiment, because the number of input lines and transmission lines of the data buses 150 and 150b decreases, the area of the routing areas RAa and RAb may decrease.

In FIG. 16, two analog areas AAa and AAb and two routing areas RAa and RAb are arranged on opposite sides of the second layer L2, but example embodiments are not limited thereto, and one analog area and one routing area may be formed on one side of the second layer L2.

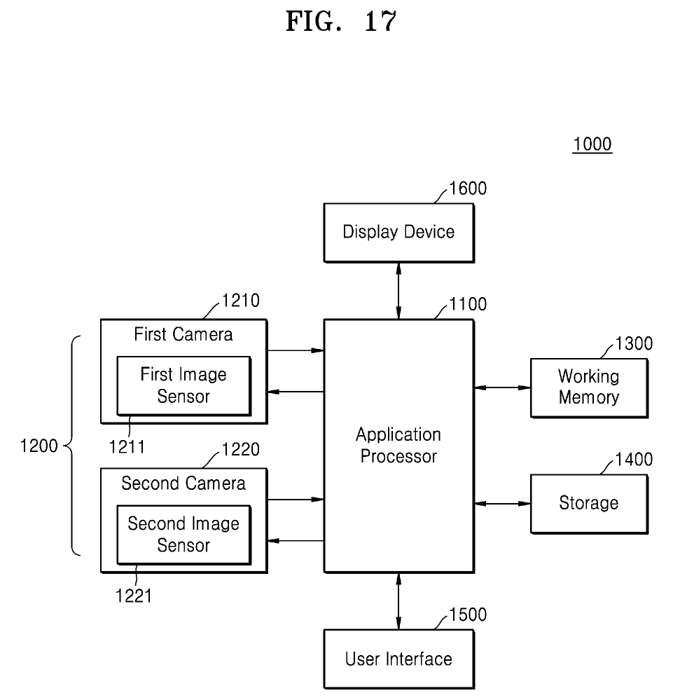

FIG. 17 is a block diagram of an electronic device 1000 including image sensors 1211 and 1221 according to an example embodiment.

The electronic device 1000 may include an electronic device having an image or light sensing function, and for example, the electronic device 1000 may include a portable terminal.

The electronic device 1000 may include an application processor 1100, a camera module 1200, a display device 1600, a working memory 1300, a storage 1400, and a user interface 1500. The electronic device 1000 may further include other components, for example, a communication module, a sensor module, etc.

The application processor 1100 may be implemented as a system on chip (SoC) which controls the overall operation of the electronic device 1000 and drives an application program, an operating system, etc. The application processor 1100 may provide the image data provided by the camera module 1200 to the display device 1600 or store the image data in the storage 1400. In an example embodiment, the application processor 1100 may include an image processing circuit, and may perform an image processing, such as image quality adjustment, data format change, and high dynamic range (HDR) processing, on the image data received from the camera module 1200.

The camera module 1200 may include a plurality of cameras, for example, a first camera 1210 and a second camera 1220. Each of the first camera 1210 and the second camera 1220 may include image sensors 1211 and 1221. At least one of a first image sensor 1211 and a second image sensor 1221 (for example, the first image sensor 1211) may be implemented as the image sensor 100 of FIG. 1 or the image sensor 100b of FIG. 11. The number of input lines and transmission lines of the data bus may be reduced, and the area of the routing area may be reduced, in which the input lines and transmission lines are formed on the layout of the semiconductor chip in which the first image sensor 1211 is formed.

The application processor 1100 may transmit sensor control signals for controlling operations of the first image sensor 1211 and the second image sensor 1221 to the first image sensor 1211 and the second image sensor 1221. The sensor control signals may include, for example, setting values and configuration data for selecting operation modes, shuttering modes, or the like of the first image sensor 1211 and the second image sensor 1221. For example, the configuration data may include an exposure time setting value, an analog gain, a digital gain, a lens shading compensation value, a crosstalk coefficient, a frame rate setting value, etc. Transmission of the sensor control signals may be performed based on, for example, an interface based on inter-integrated circuit (I2C).

The first image sensor 1211 and the second image sensor 1221 may operate based on the sensor control signals to be received. The first image sensor 1211 and the second image sensor 1221 may transmit image data or signal-processed image data to the application

processor 1100. Transmission of the image data may be performed by using, for example, a camera serial interface (CSI) based on an MIPI, but example embodiments are not limited thereto.

The working memory 2300 may be implemented as a volatile memory, such as dynamic random access memory (RAM) (DRAM) and static RAM (SRAM), or a resistive non-volatile memory, such as ferroelectric RAM (FeRAM), resistive RAM (RRAM), and phase change RAM (PCRAM). The working memory 2300 may store programs and/or data, which the application processor 1100 executes or processes.

The storage 1400 may be implemented as a non-volatile memory, such as a NAND flash memory and resistive memory, and the storage 1400 may be provided as, for example, a memory card (a multi-media card (MMC), an embedded MMC (eMMC), a secure card (SD), and a micro-SD), etc. The storage 1400 may store image data provided by the camera module 1200.

A user interface 1500 may be implemented as various devices capable of receiving a user input, such as a keyboard, a curtain key panel, a touch panel, a finger print sensor, and a microphone. The user interface 1500 may receive the user input, and provide a signal corresponding to the received user input to the application processor 1100. The application processor 1100 may control the camera module 1200 to photograph an image of an object based on a user input received by the user interface 1500.

While aspects of example embodiments have been particularly shown and described, it will be understood that various changes in form and details may be made therein without departing from the spirit and scope of the following claims.

What is claimed is:

1. An image sensor comprising:
a pixel array comprising a plurality of pixels;
an analog-to-digital converter circuit configured to convert a plurality of pixel signals received in units of rows of the pixel array into a plurality of pieces of pixel data; and
a data bus configured to transmit the plurality of pieces of pixel data to an image signal processor,
wherein the data bus comprises:
a plurality of channel memories, wherein a first channel memory among the plurality of channel memories comprises N column memories (N is an integer of 2 or more) configured to store N different pieces of pixel data among the plurality of pieces of pixel data; and
a plurality of multiplexers respectively corresponding to the plurality of channel memories, configured to share N selection signals, wherein a first multiplexer among the plurality of multiplexers is configured to sequentially select N pieces of pixel data from the first channel memory based on the N selection signals, and to output the selected pixel data as channel data.

2. The image sensor of claim 1, wherein each of the plurality of multiplexers is further configured to simultaneously output a plurality of bits of the selected pixel data.

3. The image sensor of claim 1, wherein the plurality of channel memories comprise the first channel memory and a second channel memory,
wherein the first channel memory is further configured to store first through Nth pixel data and the second channel memory is configured to store (N+1)th through (2N)th pixel data,
wherein the plurality of multiplexers comprise the first multiplexer and a second multiplexer, and
wherein the first multiplexer and the second multiplexer are configured to:
in a first cycle, respectively output the first pixel data and the (N+1)th pixel data according to a first selection signal of an enable level among the N selection signals, and
in a second cycle subsequent to the first cycle, respectively output the second pixel data and (N+2)th pixel data according to a second selection signal of an enable level among the N selection signals.

4. The image sensor of claim 1, wherein the plurality of multiplexers comprises the first multiplexer and a second multiplexer, each of the first multiplexer and the second multiplexer comprising:
a plurality of bit lines configured to receive and output bits of pixel data from selected column memory among the N column memories of a corresponding channel memory; and
N switching circuits configured to connect a corresponding column memory among the N column memories to the plurality of bit lines according to a corresponding selection signal among the N selection signals.

5. The image sensor of claim 4, wherein the N column memories extend in parallel along a second direction, and each of the N column memories comprises a plurality of bit memories each configured to store data of one bit, and
wherein the plurality of bit lines comprise:
a plurality of first bit lines extending in a first direction perpendicular to the second direction, wherein each of the plurality of first bit lines is configured to be connected to a corresponding bit memory among the plurality of bit memories of the N column memories; and
a plurality of second bit lines extending in the second direction, wherein each of the plurality of second bit lines is configured to be connected to a corresponding first bit line among the plurality of first bit lines to output voltages of the plurality of first bit lines.

6. The image sensor of claim 5, wherein each of the N switching circuits comprises a plurality of switches configured to connect a plurality of bit memories of the corresponding column memory to the plurality of first bit lines, respectively, and
wherein the plurality of switches are configured to simultaneously turn on and off according to a corresponding selection signal among the N selection signals.

7. The image sensor of claim 1, wherein the data bus further comprises a shift register configured to generate the N selection signals, based on an enable signal and a clock signal received from a timing controller.

8. The image sensor of claim 1, further comprising a timing controller configured to provide the N selection signals.

9. The image sensor of claim 1, wherein the data bus further comprises a data alignment circuit configured to align the plurality of pieces of pixel data sequentially received from the plurality of multiplexers as the channel data, and output the plurality of pieces of pixel data in units of two or more pieces of pixel data to the image signal processor.

10. The image sensor of claim 1, wherein the pixel array is provided on a first layer, and
wherein the analog-to-digital converter circuit, the data bus, and the image signal processor are provided on a second layer on the first layer.

11. An image sensor comprising:
a pixel array comprising a plurality of pixels;
an analog-to-digital converter circuit configured to convert a plurality of pixel signals received in units of rows of the pixel array into a plurality of pieces of pixel data, respectively;
a shift register configured to generate N selection signals, based on an enable signal and a clock signal;
a plurality of channel memories, wherein a first channel memory among the plurality of channel memories comprises N column memories (N is an integer of 2 or more), and is configured to store N pieces of pixel data among the plurality of pieces of pixel data; and
a plurality of multiplexers configured to share the N selection signals, wherein a first multiplexer among the plurality of multiplexers is configured to and sequentially select and output the N pieces of pixel data stored in the first channel memory based on the N selection signals.

12. The image sensor of claim 11, wherein the first multiplexer is further configured to output, during N periods, the N pieces of pixel data based on the N selection signals.

13. The image sensor of claim 11, wherein each of the plurality of multiplexers is further configured to simultaneously output a plurality of bits of the selected pixel data.

14. The image sensor of claim 11, wherein the plurality of multiplexers comprises the first multiplexer and a second multiplexer, each of the first multiplexer and the second multiplexer comprising:
a plurality of first bit lines extending in a first direction, wherein each of the plurality of first bit lines is configured to be connected to a corresponding bit memory among a plurality of bit memories of the N column memories;
a plurality of second bit lines extending in a second direction perpendicular to the first direction, wherein each of the plurality of second bit lines is configured to be connected to a corresponding first bit line among the plurality of first bit lines, and to output voltages of the plurality of first bit lines; and
N switching circuits, wherein each of the N switching circuits is configured to connect a corresponding column memory among the N column memories to the plurality of first bit lines according to a corresponding selection signal among the N selection signals.

15. The image sensor of claim 11, further comprising a data alignment circuit configured to align the plurality of pieces of pixel data received during a plurality of periods from the plurality of multiplexers, and output the aligned plurality of pieces of pixel data in units of two or more adjacent pieces of pixel data to an image signal processor.

16. A method of operating an image sensor, the method comprising:
outputting, by a pixel array, a plurality of pixel signals;
converting, by an analog-to-digital converter circuit, the plurality of pixel signals to a plurality of pieces of pixel data;
receiving, by each of a plurality of channel memories, N different pieces of pixel data (N is an integer of 2 or more) among the plurality of pieces of pixel data; and
sequentially outputting, by each of a plurality of multiplexers, N pieces of pixel data stored in a corresponding channel memory among the plurality of channel memories based on N selection signals, the N selection signals being shared by the plurality of multiplexers.

17. The method of claim 16, further comprising generating, by a shift register, the N selection signals, based on an enable signal and a clock signal.

18. The method of claim 16, wherein the sequentially outputting of the N pieces of pixel data comprises simultaneously outputting, by a first multiplexer of the plurality of multiplexers, a plurality of bits of the selected pixel data.

19. The method of claim 16, wherein the sequentially outputting of the N pieces of pixel data comprises:
outputting during a first period, by a first multiplexer of the plurality of multiplexers, first pixel data among the N pieces of pixel data; and
outputting during a second period subsequent to the first period, by the first multiplexer, second pixel data among the N pieces of pixel data.

20. The method of claim 16, further comprising:
receiving and aligning, by a data alignment circuit, the plurality of pieces of pixel data from the plurality of multiplexers; and
outputting, by the data alignment circuit, the plurality of pieces of pixel data in units of two or more adjacent pieces of pixel data to an image signal processor.
